(19) United States
(12) Patent Application Publication
(10) Pub. No.: US 2022/0169401 A1
(43) Pub. Date: Jun. 2, 2022

(54) SMART CITY SMART DRONE UASS/UAV/VTOL SMART MAILBOX LANDING PAD

(71) Applicant: Michele Di Cosola, Bloomingdale, IL (US)

(72) Inventor: Michele Di Cosola, Bloomingdale, IL (US)

(21) Appl. No.: 17/187,871

(22) Filed: Feb. 28, 2021

Related U.S. Application Data
(63) Continuation-in-part of application No. 16/866,484, filed on May 4, 2020.
(60) Provisional application No. 62/983,486, filed on Feb. 28, 2020.
(60) Provisional application No. 62/842,757, filed on May 3, 2019.

(51) Int. Cl. B64F 1/36; B60L 53/12; B64F 1/32; B64C 39/02; B64F 1/20; B60L 53/51; H02J 50/10

(52) U.S. Cl. CPC B64F 1/362; B60L 53/12; B64F 1/32; B64C 39/024; B64F 1/20; G05D 1/1062; H02J 50/10; B60L 2200/10; B64C 2201/128; H02J 2300/22; B60L 53/51

(57) ABSTRACT

A system and method for providing smart drone mailbox landing pads and charging stations is a component of a drone unmanned system service network. The drone unmanned system service network communicatively connects the smart drone mailbox landing pad and charging station, one or more autonomous drones, and one or more drone service function devices to provide autonomous drone package delivery over a communications network. The smart drone mailbox landing pad and charging station includes a processing node having a processor, memory, a storage device, and a network connection to one or more communications networks, a drone landing pad, an induced charging pad configured to recharge a battery within one of the one or more drones, one or more external webcams, weather equipment, and a package receiving container for accepting a delivered package, while using blockchain harvesting, mining, logging and recording, for the entire process where and as needed.

### CROSS-REFERENCE TO RELATED APPLICATIONS

This application claims priority as a Continuation-in-Part to U.S. patent application Ser. No. 16/866,484, titled “SMART DRONE ROOFTOP AND GROUND AIRPORT SYSTEM,” and filed on May 4, 2020, that itself claims priority to U.S. Provisional Patent Application No. 62/842,757, filed May 3, 2019 titled “UNIVERSAL AUTOMATED ARTIFICIAL INTELLIGENT ROOFTOP UAS/UAV DRONE PORT/AIRPORT STATION FOR GENERAL PURPOSE SERVICES OF ROBOTIC UAS/UAVS, AND ITS SUPPORTING HARDWARE & EQUIPMENT RELATED TO; LOADING/UNLOADING DELIVERIES, DEPLOYMENT/ARRIVAL, DISPATCHING, AIR TRAFFIC CONTROL, CHARGING, STORING/GARAGING, DE-lcING/ANTI-lcING, METEOROLOGICAL & DATA DISSEMINATION/RETRIEVAL, BIG DATA MINING AND MIMO NETWORK SERVICES.” This Application also claims priority to U.S. Provisional Patent Application No. 62/983,486, titled “SMART CITY SMART DRONE UAS/UAV/VTOL MAILBOX LANDING PAD, filed Feb. 28, 2020.

This application also is related to U.S. Provisional Patent Application No. 63/154,746, titled “Artificial Intelligence Machine Learning—AIML SMS, SRM, CRM, QMS & Blockchain Cyber Security System for Unmanned Aircraft Vehicles UAV Systems, filed Feb. 28, 2021. These applications are incorporated herein by reference in their entirety.

### TECHNICAL FIELD

The embodiments provided herein for this application relates in general to a system and method for providing unmanned aerial vehicles (UAV), vertical take-off and landing vehicles (VTOL), electronic vertical take-off and landing vehicles (eVTOL) unmanned vehicle operating systems, unmanned traffic management systems (UTM), air traffic control systems (ATM), and unmanned and manned airport facilities thereof, and more specifically, to a system and method for providing smart mailbox landing pad, charging and storage stations.

### BACKGROUND

Smart drones, autonomous flying devices, and similar unmanned vehicles are being developed to perform delivery tasks for vendors of all kinds, including retail establishments, restaurants, and related food service providers. Systems employing these autonomous flying devices are being integrated into larger systems that may include point-of-sale components, autonomous flying devices, dispatch, routing, and control components, such that these systems may be provided as a service to business establishments as needed.

The autonomous flying devices in some embodiments may fly numerous flights making deliveries before being free to return to a base station. These smart drones may require an ability to find a smart landing pad on numerous locations within its service area in order to deliver items to customers. These smart landing pads provide a secure location to permit the smart drones to land, deliver, and or temporarily store packages, while still having a manual hybrid delivery use and the ability to provide scalability and modulation hardware and software services and applications, with the ability to act as a charging station for the recharge of the unmanned arial vehicle, provide cloud exchange of big data, mining, logging, and recording via blockchain and Internet of Things (IoT), in order to provide a system that distinguishes itself from the above-defined landing platforms by offering a fully interactive, end-user customized, smart drone landing pad with an autonomous mailbox. A novel landing pad/mailbox, disclosed herein as the Smart Mailbox Landing Pad, due to its capability of utilizing the most advanced communications systems to interact with various state and federal agencies, and the air traffic and meteorological management programs managed by said agencies and third parties, including but not limited to the Unmanned Aircraft System Traffic Management (UTM), 4-Dimensional Data Cube Network, the Next Generation Air Transportation System (NextGen), Smart Unmanned Arial System (SUAS) for Drone Delivery and Smart Drone Rooftop and Ground Airport—Safety Management System (SMS)—Safety Risk Management System (SRM)—Quality Management System (QMS) & Processes, and Blockchain Systems.

Therefore, a need exists for a system and method for providing smart mailbox landing pads. The present invention attempts to address the limitations and deficiencies of existing solutions according to the principles and example embodiments disclosed herein.

### SUMMARY

In accordance with the present invention, the above and other problems are solved by providing a system and method for providing smart mailbox landing pads according to the principles and example embodiments disclosed herein.

In one embodiment, the present invention is a system for providing smart mailbox landing pads is a component of a drone unmanned system service network. The drone unmanned system service network communicatively connects the smart drone mailbox landing pad, one or more autonomous drones, and one or more drone service function devices to provide autonomous drone package delivery over a communications network. The smart drone mailbox landing pad includes a processing node having a processor, memory, a storage device, and a network connection to one or more communications networks, a drone landing pad, an induced charging pad configured to recharge a battery within one of the one or more drones, one or more external webcams, and a package receiving container for accepting a delivered package.

In another embodiment of the present disclosure, the one or more autonomous drones comprises an unmanned aircraft system, an unmanned aircraft vehicles, a vertical take-off and landing vehicle, an electric vertical take-off and landing vehicle, a vertical short take-off and landing vehicle, an electric vertical short take-off and landing vehicle, a short take-off and landing vehicle, an electric short take-off and landing vehicle, a conventional take-off and landing vehicle, an electric conventional take-off and landing vehicle, a cargo air vehicle, an electric cargo air vehicle, a passenger air vehicle, hydrogen unmanned vehicle, a hydrogen and electric unmanned vehicle hybrid, and an electric passenger air vehicle.

In another embodiment of the present disclosure, the smart drone mailbox landing pad further a telescoping support tube, landing sensors, beacon lights, solar panels, a display device, and an input keypad.

In another embodiment of the present disclosure, the package receiving container includes an automatic opening and locking access point, temperature and environmental control system, modular storage components, and an internal webcam.

In another embodiment of the present disclosure, the smart drone mailbox landing pad further includes a remote smart doorbell, and a wireless smart watch. The remote smart doorbell and the wireless smart watch receive package delivery notification from the processing node within the smart drone mailbox landing pad upon receipt of a package.

In another embodiment of the present disclosure, the processing node within the smart drone mailbox landing pad downloads mobile applications containing executable instructions for the processor to perform from a 3d party vendor.

In another embodiment of the present disclosure, the node within the smart drone mailbox landing pad communicates with a network controller of the one or more autonomous drones to receive authorization for a particular drone to land.

In another embodiment of the present disclosure, the node within the smart drone mailbox landing pad communicates with the particular drone to provide authorization to land.

In another embodiment of the present disclosure, the node within the smart drone mailbox landing pad unlocks and opens the access point to permit the delivery of a package.

In another embodiment of the present disclosure, the smart drone mailbox landing pad further comprises weather condition measuring equipment to obtain current weather conditions about the smart drone mailbox landing pad.

In another embodiment of the present disclosure, the node within the smart drone mailbox landing pad provides the current weather conditions to the one or more autonomous drones and the one or more drone service function devices of the drone unmanned system service network.

In another embodiment of the present disclosure, the one or more drone service function devices of the drone unmanned system service network comprise a drone flight planner, a drone request system, a drone system state device, a drone mission checker, a device authentication authority, a point-of-sale system, and one or more rooftop airport and or ground airports, drone garages and or hangers and charging stations and charging stations.

In another embodiment of the present disclosure, the node of the smart drone mailbox landing pad further includes a peripheral interface for connecting 3d party devices for use by the node and a blockchain processor of providing a blockchain harvesting, mining, logging, ledger and recording for use with other blockchain harvesting, mining, logging, ledgers, and recording, in other nodes within the drone unmanned system service network to provide a secure and redundant record of all deliveries and autonomous drone flights.

In another embodiment of the present disclosure, the blockchain processor is accessible by 3d party nodes.

In another embodiment of the present disclosure, the 3d party nodes may be added to the smart drone mailbox landing pad to provide functionality of the downloaded mobile applications.

In another embodiment of the present disclosure, the 3d party nodes added to the smart drone mailbox landing pad utilize a separate processor and memory components.

In another embodiment of the present disclosure, the 3d party nodes utilize a separate network connection to communicate with other nodes.

In another embodiment of the present disclosure, the smart drone mailbox landing pad further comprises a battery for use when solar panels are not sufficient to support the node of the smart drone mailbox landing pad.

In another embodiment of the present disclosure, the smart drone mailbox landing pad further comprises a remote control device to operate the nodes of the smart drone mailbox landing pad.

In another embodiment of the present disclosure, the telescoping operates automatically in a handicap user mode to raise and lower the smart drone mailbox landing pad.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIGS. 1a-d illustrate example embodiments of a system and method for providing smart mailbox landing pads according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIGS. 3a-d illustrate example embodiment of a system providing smart drones, unmanned arial vehicles (UAVs), vertical take-off and landing vehicles (VTOLS), electronic vertical take-off and Landing Systems (eVTOL), and smart drones, UAVs, VTOLS, eVTOL—charging, launching, storing, and renting stations, according to the present invention.

FIG. 4a-h illustrate example embodiments of a smart mailbox landing pad for use in package delivery to a customer according to the present invention.

FIGS. 5a-d illustrate additional embodiments of a smart mailbox landing pad for use in package delivery to a customer according to the present invention.

FIGS. 6a-d illustrate example embodiments of Smart Drone/Unmanned Aerial Vehicle (UAV/VTOL) Charging, Launching, Landing and Storing Stations according to the present invention.

FIG. 7a-c illustrates a schematic of the drone airport system, according to some embodiments, including the unmanned systems services network, according to some embodiments, the communications involved in reserving and implementing a landing procedure, according to some embodiments, and the communications involved in reserving and implementing a take-off procedure, according to some embodiments.

FIG. 8 illustrates a computing system of software components of a system providing smart mailbox landing pad according to the present invention.

### DETAILED DESCRIPTION

This application relates in general an autonomous drone delivery system, and more specifically, to a system and method for providing smart mailbox landing pads according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The term “mobile application” refers to an application executing on a mobile device such as a smartphone, tablet, and/or web browser on any computing device.

The terms “customer” and “user” refer to an entity, e.g., a human, using smart landing pad system to receive packages including any software or smart device application(s) associated with the invention. The term “user” herein refers to one or more users.

The term “connection,” refers to connecting any component as defined below by any means, including but not limited to, a wired connection(s) using any type of wire or cable for example, including but not limited to, coaxial cable(s), fiberoptic cable(s), and ethemet cable(s) or a wireless connection(s) using any type of frequency/frequencies or radio wave(s). Some examples are included below in this application.

The term “invention” or “present invention” refers to the invention being applied for via the patent application with the title “SMART CITY SMART DRONE UAS/UAV/VTOL MAILBOX LANDING PAD.” Invention may be used interchangeably with landing pad.

The terms “communicate,” or “communication” refer to any component(s) connecting with any other component(s) in any combination for the purpose of the connected components to communicate and/or transfer data to and from any components and/or control any settings.

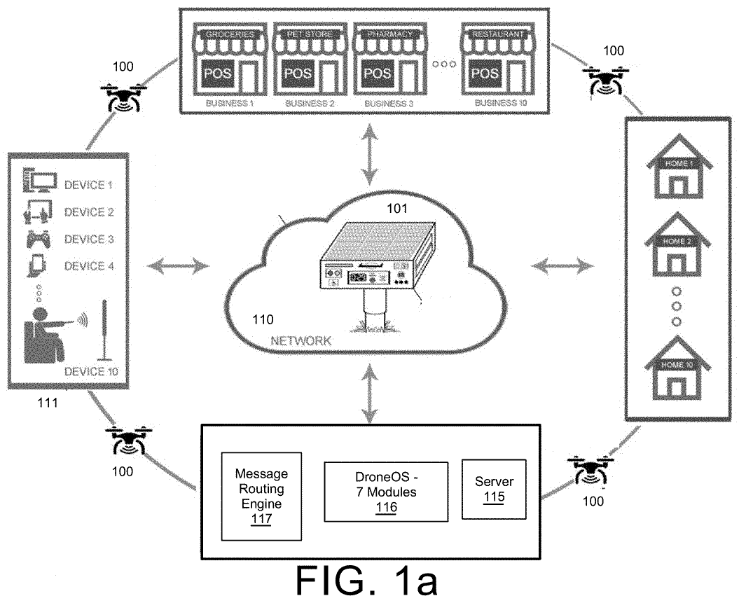

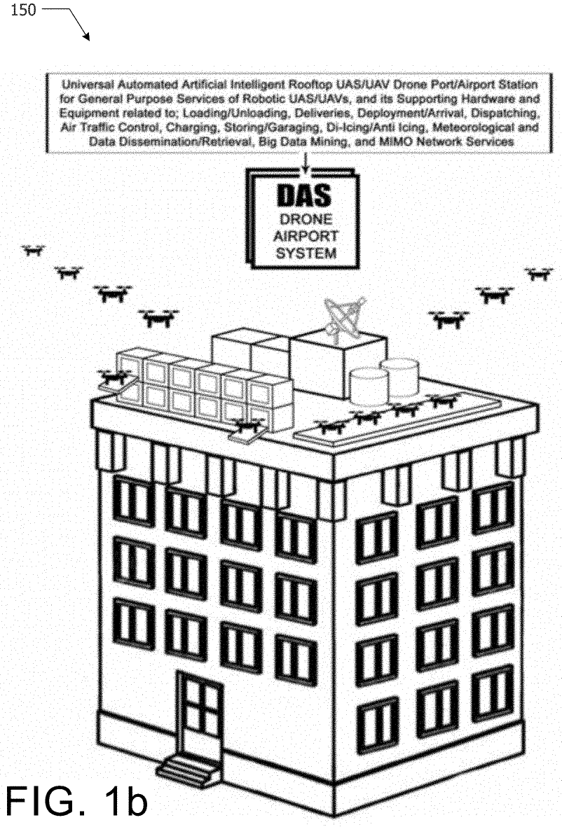

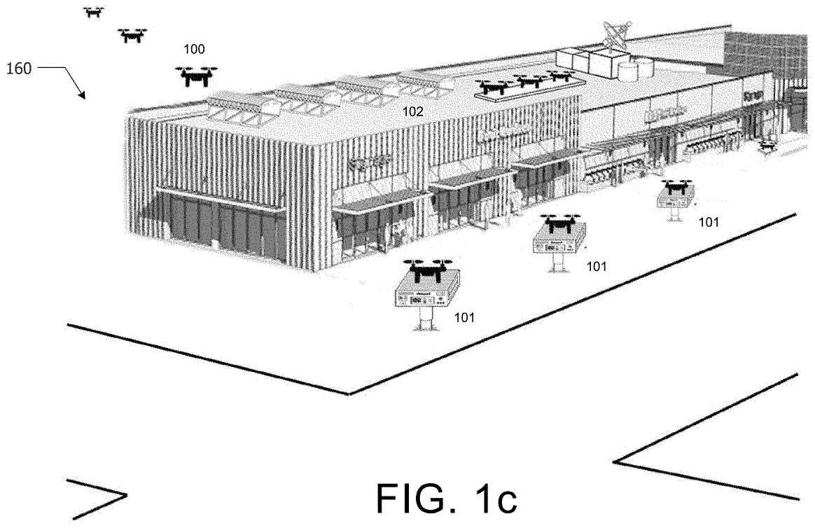

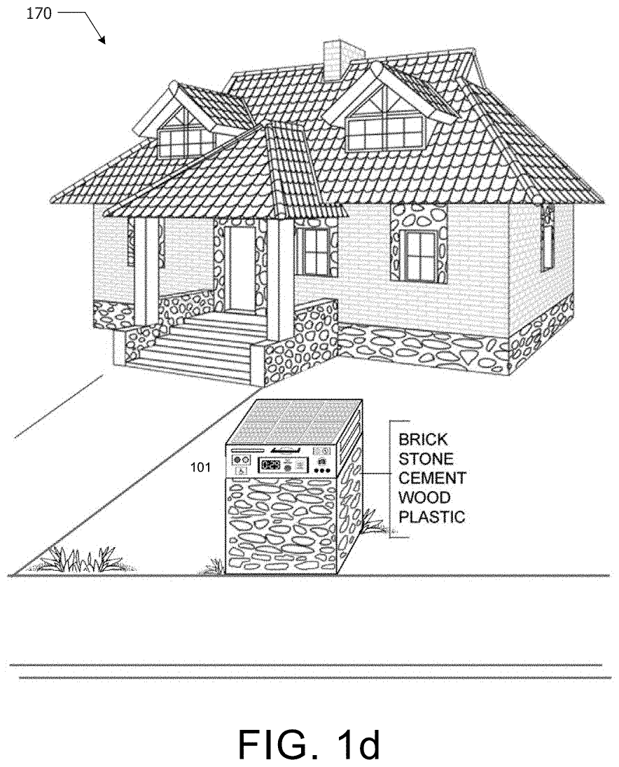

The present disclosure relates a system and method for providing smart mailbox landing pads. To better understand the present invention, FIGS. 1a-d illustrate example embodiments of a system and method for providing smart mailbox landing pads according to the present invention. The SMART CITY SMART DRONE UAS/UAV/VTOL MAILBOX LANDING PAD 101 (Smart Mailbox Landing Pad Mailbox), is designed to accept parcel and carrier deliveries performed by unmanned aerial vehicles, commonly referred to as drones, but is also a hybrid use capable of accepting manual delivery by a human. The end-user controls The Smart Drone Mailbox Landing Pad and Charging Station 101 via a mobile software application (mobile app.), utilizing navigation services such as satellite, Global Positioning Systems (GPS), Global Navigation Satellite System, Global Navigation Satellite System (GNSS), and the fifth-generation wireless technology communication protocols (5G), scalable down from 4G LTE to 4G and Scalable up for future generations. The mobile app. is designed to initiate any/all functional features of the Smart Mailbox Landing Pad 101, and to provide the end-user with notices addressing the pending deliveries, environmental conditions, and related thereto collection and distribution of data.

In addition to the 5G communication technology the Smart Mailbox Landing Pad 101 combines a wide variety of communication systems including but not limited to mobile communication standard (LTE Advanced), Internet of Things (IoT) and associated therewith Smart City Data and Smart HVAC collection modules, along with object recognition with seek and avoid cameras and transponder modules, as well as Pre-Flight Inspections, No Permission No Take-Off (NPNT), Safety Management System (SMS), Safety Risk Management (SRM) System, Safety Risk Assessment (SRA) System, Virtual Crew Resource management (AIML CRM) System, Quality Management System (QMS), AIML Mitigation Risk Assessment (AIML MRA), Hazard Risk Identified (HRI), AIML Risk Controls (AIML RC), AIML Safety Assurance (AIML SA) Modules. Automated AIML Universal Code and Rulemaking and enforcement adoption, integration and scalability system from public institutions other governing bodies, public and private groups and organizations. Examples of Public Private Participation (PPP) options not limited to: Automated updates from Joint Authorities for Rule-Making on Unmanned Systems (JARUS), European Operational Risk Assessment (SORA), American Society for Testing and Materials (ASTM) standards for operational risk and Operational Risk Assessment (ORA), Drone Industry Insights (DRONEII), National Aeronautics and Space|Adnr1llislrHtion (NASA\ the Federal Aviation Administration (FAA), Safety Data Collection and Processing System (SDCPS), EUROCONTROL's ESARR 3, Air Traffic Service Providers (ANSPs), Unmanned Traffic Management Systems (UTM), Low Altitude Authorization and Notification Administration (LAANCE), and other participating public and private rule-making and enforcing body and stake-holder Modules.

Using the above-defined technology, the Smart Mailbox Landing Pad 101 will be capable of engaging into Block Chain Data Mining, Logging, Recording (focusing on mining of block chain currency, transaction ledgering, pre-flight flight, enroute and delivery logging, parts and maintenance logging, meteorology event logging, SMS, SRM, SRA, QRM, AIML CRM, SA, HRI, AIML MRA, NPNT, and other above herein systems); incorporate Data Sharing Services offered to both local and federal agencies as well as private participation partnerships (PPP) and third-party service companies, thus building and utilizing smart city or the first responder data; and offer the Micro-Cloud Services by converting the network of Smart Mailbox Landing Pads and Charging Station 101 into instantaneous and reliable source of localized, cloud-based network services as a true “last mile logistics”.

The end-users may utilize the mobile app. with a wide variety of wired and wireless devices, including but not limited to personal computers, tablets, video games, video game consoles, video game controllers and accessories, smart phones, smart televisions, smart television controllers and accessories, smart refrigerators and other contemporary communication devices.

As shown in FIG. 1a the proper operation of the Smart Mailbox Landing Pad and Charging Station is highly depended on a reliable cloud-based network. The Smart Mailbox Landing Pad and Charging Station utilizes a proprietary Operating System (OS) and Drone Operating System (DOS) 116, comprising of 7 modules: I) OS Module I—applications operating system for in-house and third-party platforms/applications (Apple IOS, Android, Roku); 2) OS Module 2—ready for ANSP, UTM, USS, LAANC, ATC, UAM, GATSS, SBAS, GPS, IMU, Telemetry Systems, Radar, SBAS, US Data Exchange, USS, Laser Scanner, RANSAC, SOD, FLA, RF, RFID, RTLC, ATL, Barcodes, Static QR Codes, Dynamic QR Codes, SLAM, EKF, RWI, VPS, Clustering, IRS Rising Laser Gyro, IRS, MEMS Accelerometer Gyroscope Management System, PEVS, UTM, and ANSP airspace management systems integration via cloud; 3) OS Module 3—ready for NEXGEN network participating systems communications and data sharing; 4) OS Module 4—ready for DOS, POS, Network System, U.S. Postal System (U.S.P.S.), Third Party Carrier Systems and DAS system integration and data sharing for any platform such as smart cities or first responders. 5) OS Module 5—Block Chain Management System via cloud. 6) OS Module 6—Block Chain Data Mining System. 7) OS Module 7—Cyber Security Network System for entire network. Module 7—the Massive MIMO and cloud-based artificial intelligence and machine learning (AIML).

FIG. 1b shows the present invention containing modular containers for fixed and disposable containers used by smart drones that is part of a larger system having a UAS/UAV rooftop drone-port/airport, comprising charging, de-icing, anti-icing, storing and parking garage/hanger services, which provide the following capabilities: drone-on-demand delivery services; drones parked, stored, and/or charging in the drone garage/hanger and/or on a drone landing pad; orders made via mobile, land, and TV applications using wired and/or wireless connections; drone AI ML (artificial intelligence and machine learning) Cloud determines if weather permits delivery to and from the location requested at the time requested; and drone Cloud determines drone availability using the most properly charged, operable, fastest, most convenient, safest, and properly equipped drone, smart drone mailbox landing pad and charging station, and landing pad, for the weather conditions, payload requirements, size requirements, sensitivity, and any other specific demand option(s).

The Unmanned Aircraft System Traffic Management (UTM) web server 115 deploys the drone to the landing pad 101 for loading/unloading, drop off, and pickup. The drone 100 is loaded and departs to its destination. The drone 100 arrives at its destination, confirms the receiver of the package, releases the product to the consumer, and informs the POS that the order has been delivered. The drone AI ML running on the UTM web server 115 then selects either the drone's next destination based upon its remaining battery use, and sends it to its next order, or it parks the drone at the nearest drone airport parking station 600 where it can recharge and wait for further instructions.

All rooftop DAS/drone hardware 100 exterior and/or interior equipment and landing pad equipment 101 will have a waterproof option such as superhydrophobic (water) and oleophobic (hydrocarbon) coating, that will completely repel almost any liquid, and/or nanotechnology coating, to coat the drone and create a barrier of air on its surface.

All DAS/drones 100 that deploy will have the option to use DAS/UAV de-icing inflatable boot equipment on the leading and trailing edges of the propeller arm(s). All DAS/drone hardware will have impact protection options, using products like Mashable D30 Crystallex clear, formable elastomer material as protective gear on the DAS/drones for drop test crash resistance. In addition to deployable airbag(s), parachute(s), extra battery(ies), telescopic landing legs that will help to mitigate impact and damage.

The DAS/drone hardware 100 will have nanocrystalline metal alloy options for a lighter, stronger, and more efficient DAS.

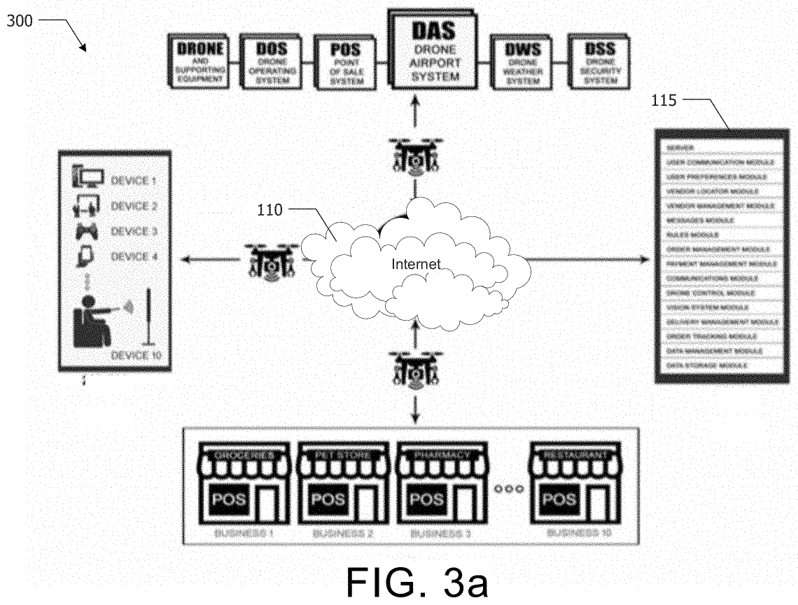

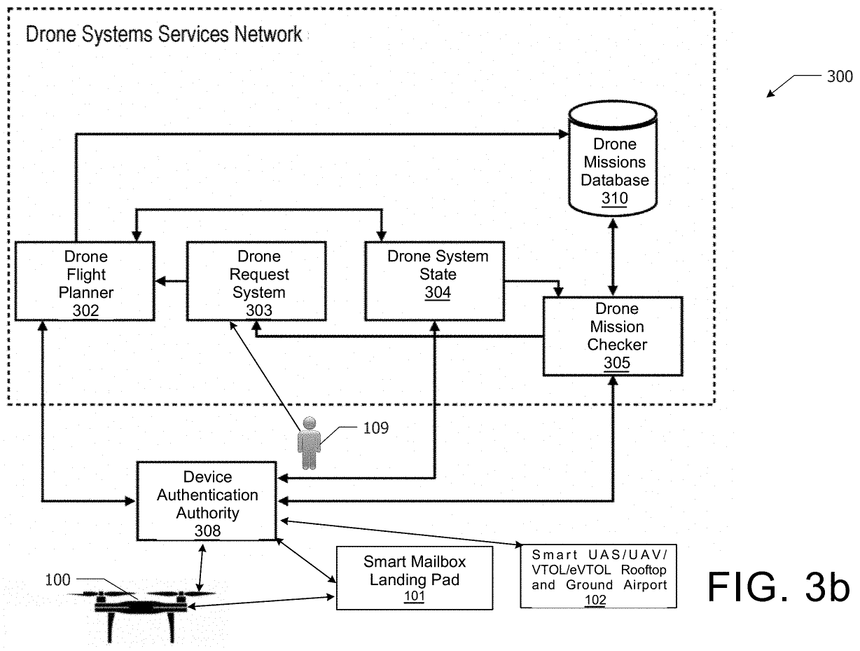

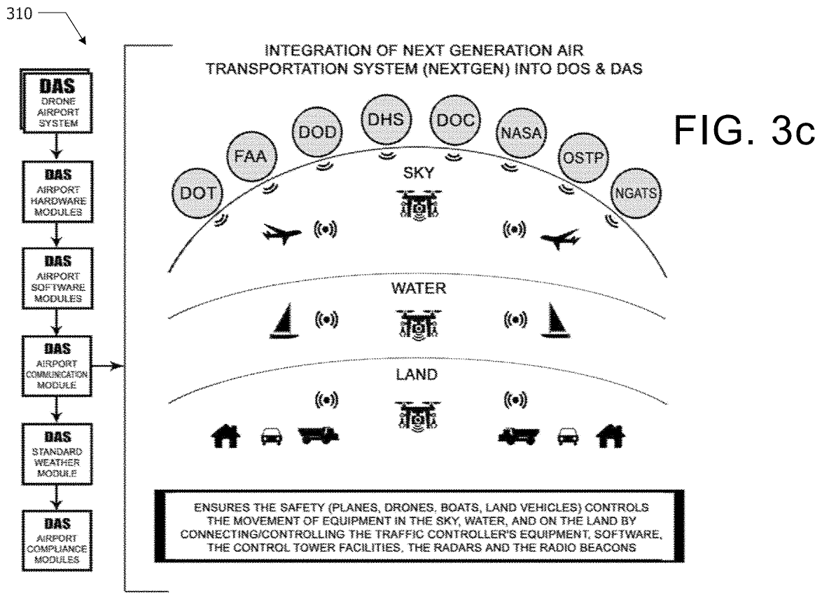

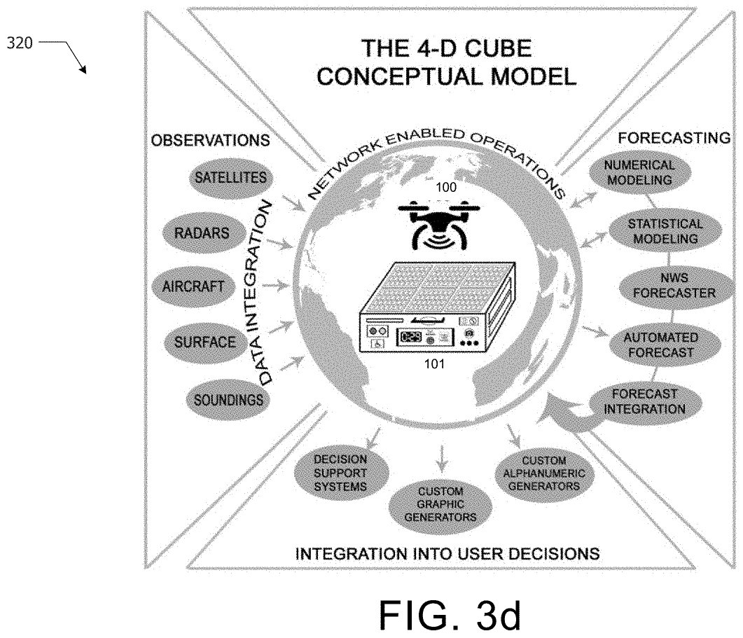

The Smart Drone Rooftop and Ground Airport System also referred to as Smart Drone Airport System (SDAS) 300, as described in detail below in reference to FIG. 3a-d, has been designed to provide options for the following services: 1) less than load delivery (LTL); 2) document delivery services; 3) distribution center delivery; 4) freight on board (FOB) delivery; cost, insurance, and freight (CIF) delivery; 5) cost, no insurance, freight (CNF) delivery; 6) rideshare package delivery; 7) rideshare person delivery; 8) ride hailing; 9) on-demand location- and service-based DAS/drone hiring; 10) private and public use hiring; 11) take away delivery; 12) parking, storing, garaging, charging, de-icing, anti-icing, and docking; 13) warehousing delivery; 14) customs and port security delivery drop offs; 15) perishable and non-perishable foods and product delivery; and 16) special product temperature and packaging deliveries such as medications, specimens, lab testing kits, and test results.

As shown in FIG. 1b, the SDAS 300 is illustrated operating from the rooftop of a commercial building. Visible are two rows of stackable drone garage systems, two liquid tanks containing the de-icing/anti-icing agent (for roof surface, drone, smart drone mailbox landing pad and charging station, charging station, smart drone garage/hanger), landing pad, radar system, and communications system. The airport also contains a drone loading/unloading landing pad station system, which may be used for manual battery swaps and as a cleaning station.

FIG. 1c is perspective view of a low commercial structure housing on its roof the Drone Airport System 300, and utilizing at the street level a plurality of landing pads, specifically the SMART CITY SMART DRONE UAS/UAV/VTOL MAILBOX LANDING PADS 101, designed to depict the ability of the landing pad to interact with various drone airport components, including but not limited to drone hangars, landing pads, charging stations, mailboxes and stationary weather forecasting equipment, navigation equipment, security equipment, safety equipment, lighting equipment, network equipment, attached to said airport, in accordance with an exemplary embodiment of the present invention.

FIG. 1d is a perspective view of the SMART CITY SMART DRONE UAS/UAV/VTOL MAILBOX LANDING PAD 101, positioned in front of a single-family home, designed to show the available external paneling options, incorporating but not limited to brick, stone, cement, wood, and plastic, in accordance with an exemplary embodiment of the present invention. In addition to solar panel options.

The invention may use any type of network such as a single network, multiple networks of a same type, or multiple networks of different types which may include one or more of a direct connection between devices, including but not limited to a local area network (LAN), a wide area network (WAN) (for example, the Internet), a metropolitan area network (MAN), a wireless network (for example, a general packet radio service (GPRS) network), a long term evolution (LTE) network, a telephone network (for example, a Public Switched Telephone Network or a cellular network), a subset of the Internet, an ad hoc network, a fiber optic network (for example, a fiber optic service (often known as FiOS) network), or any combination of the above networks.

Smart devices mentioned herein the present application may also use one or more sensors to receive or send signals, such as wireless signals for example, Bluetooth™, wireless fidelity, infrared, Internet of Things (IoT), Wi-Fi, or LTE. Any smart device mentioned in this application may be connected to any other component or smart device via wired communications (e.g., conductive wire, coaxial cable, fiber optic cable, ethernet cable, twisted pair cable, transmission line, waveguide, etc.), or a combination of wired and wireless communications. The invention's method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the invention's systems and methods is not limiting of the implementation. Thus, the operation and behavior of the systems and methods were described without reference to the specific software or firmware code. Software, smart device application(s), firmware, and control hardware can be designed to implement the systems and methods based on the description herein.

This new invention also has the ability to manage, control or communicate with multiple or unlimited number of smart drones 100, smart mailbox landing pad and charging station 101, launching and charging stations 600, from one or more server or computer system 115 location without the intervention of the operator or operators or anyone with access or privileges to use this new invention. Although, manual override use and or intervention is also a feature. For example, one or more drones 100 can be managed or controlled or communicated with one or more servers, computer systems, or smart devices from one or more locations. To further exemplify, the user will be able to control or communicate with as many smart drones 100 and smart mailbox landing pads 101 as desired from one centralized location if desired or more than one location.

While all of the above functions are described to be provided to users via a mobile application on a smartphone, one of ordinary skill will recognize that any computing device including tablets, laptops, and general purpose computing devices may be used as well. In at least one embodiment, all of the services described herein are provided using web pages being accessed from the web server 201 using a web browser such as Safari™, Firefox™, Chrome™ DuckDuckGo™, and the like. All of the screen examples described herein show user interface elements that provide the functionality of the present invention. The arrangement, organization, presentation, and use of particular user input/output (I/0) elements including hyperlinks, buttons, text fields, scrolling lists, and similar 1/0 elements are shown herein for example embodiments only to more easily convey the features of the present invention. The scope of the present invention should not be interpreted as being limited by any of these elements unless expressly recited within the attached claims.

For the purposes of the example embodiment of FIGS. 1a-c, various functions are shown to be performed on different programmable computing devices that communicate with each other over the Internet 110. These computing devices 111 may include smartphones, laptop computers, kiosks, tablets (not shown), and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. It may be communicating as a daisy chained function together for more power and speed, such as quantum computing. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), on a cyber security hardware, software and or cloud network or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

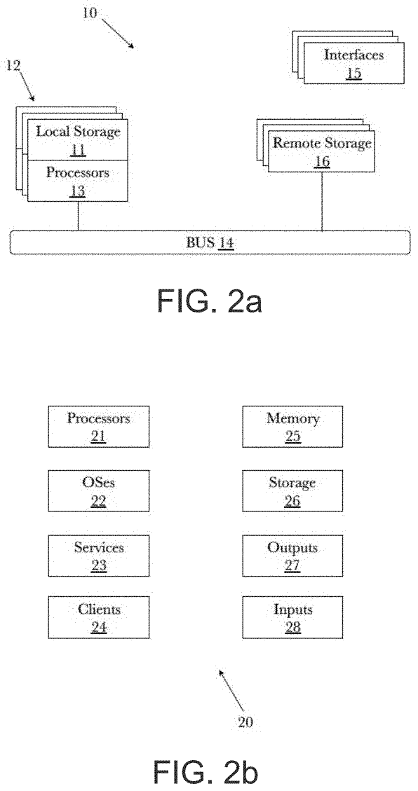

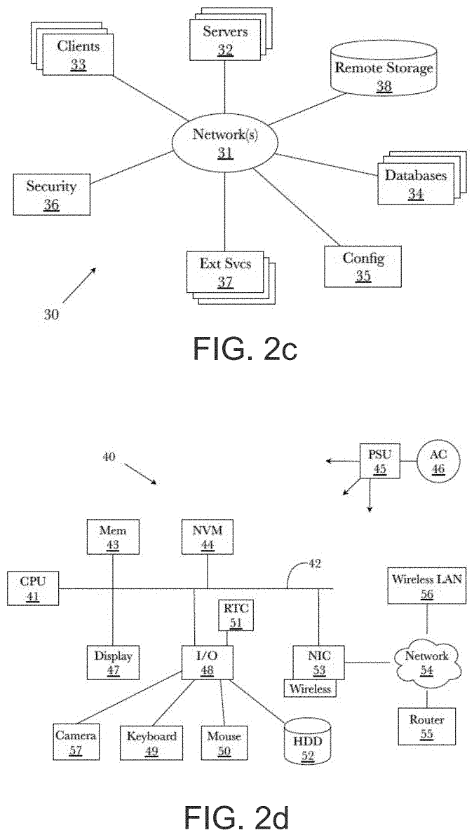

Referring now to FIG. 2a, there is a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network, a metropolitan area network, a local area network, a wireless network, the Internet, cloud network, cyber security networks, cyber security hive networks, or any other network, using known protocols for such communication, whether wireless or wired.

In one aspect, computing device 10 includes one or more central processing units (CPU) 12, one or more interfaces 15, and one or more buses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may be caused to perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random access memory (RAM) and/or read-only memory (ROM), including for example, one or more levels of cached memory) may also form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-a-chip-(SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as, for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, fiber data distributed interfaces (FDDis), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, big data, blockchain data mining, logging and recording or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “interoperable” internal and external devices, hardware, components, “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a JAVA™ virtual machine or equivalent, or files containing higher level code that may be executed by the computer using an interpreter (for example, scripts written in Python™, Perl™, Ruby™, Groovy™, virtual reality augmented reality and mixed reality languages, or any other scripting language.

In some aspects, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the LINUX™ operating system, ANDROID™ operating system, Drone Operating System (DOS)™ or the like. In many cases, one or more shared services 23 may be operable in system 20, and may be useful for providing common services to client applications 24. Services 23 may, for example, be WINDOWS™ services, user-space common services in a LINUX™ environment or any other type of common service architecture used with an operating system 22. Input devices 28 may be of any type suitable for receiving user input including, for example, a keyboard, touchscreen, microphone (for example, for voice input), mouse, touchpad, trackball or any combination thereof. Output devices 27 may be of any type suitable for providing output to one or more users, whether remote or local to system 20, and may include, for example, one or more screens for visual output, speakers, printers or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, Cloud storage, and the like.

In some aspects, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 2b. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to bus 42, to which bus is also connected to memory 43, non-volatile memory 44, display 47, 1/0 unit 48, and network interface card (NIC) 53. An 1/0 unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46 or (DC) supply (not shown) or a combination or conversion of either two. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

FIG. 3a illustrates an example embodiment of a system providing smart drones and smart drone charging and launching stations according to the present invention. FIG. 3 shows a the SDAS relies on a fast, cloud-based Unmanned System Service Network (USSN) consisting of nodes and services, using but not limited to, GPS, Massive MIMO 4G or 5G, and 4G or 5G LTE to maintain constant and reliable communications with drones and other interactive components, such as business entities and end-user wired/wireless communication devices. The network also must be able to maintain a reliable connection with the server and be compatible with various supportive systems including the drone operating system (DOS), point of sale system (POS), drone weather system, drone security system, smart drone mailbox landing pad and charging system, and smart landing pad system. Device IO can also include but not be limited to, in-vehicle computer systems such as navigation or multimedia systems in automobiles or other integrated hardware devices, smart appliances, and a smart watch.

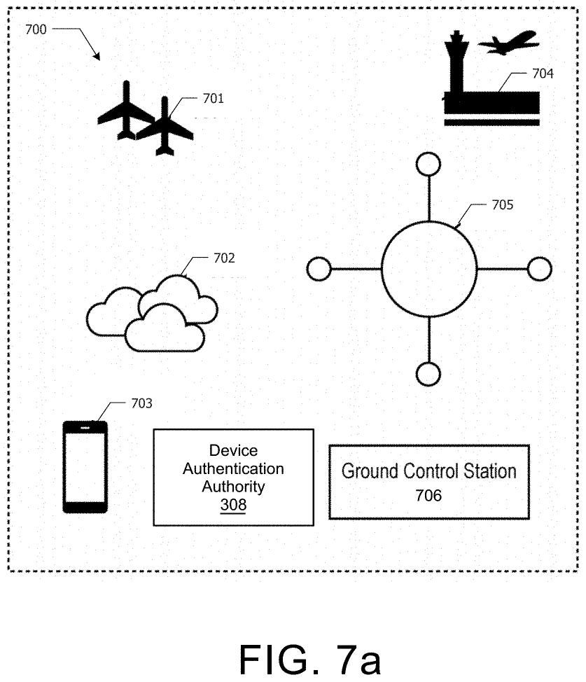

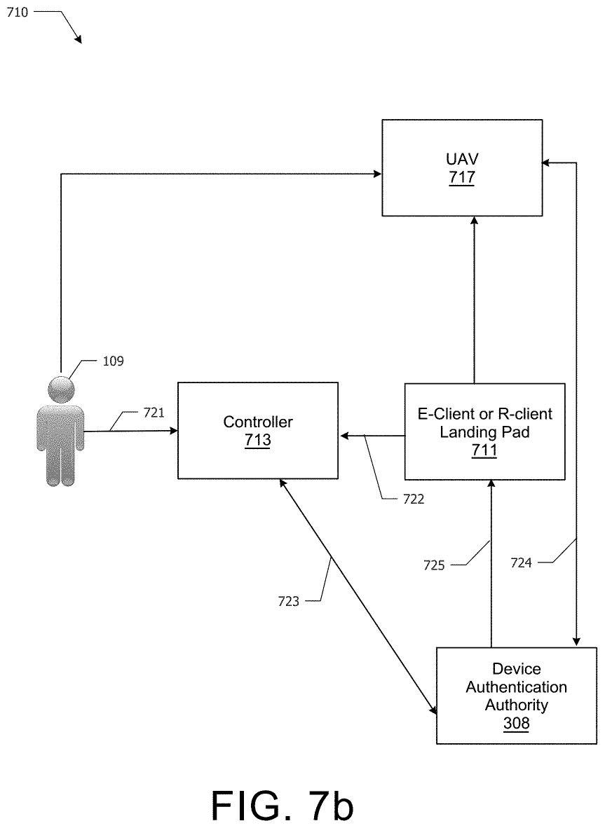

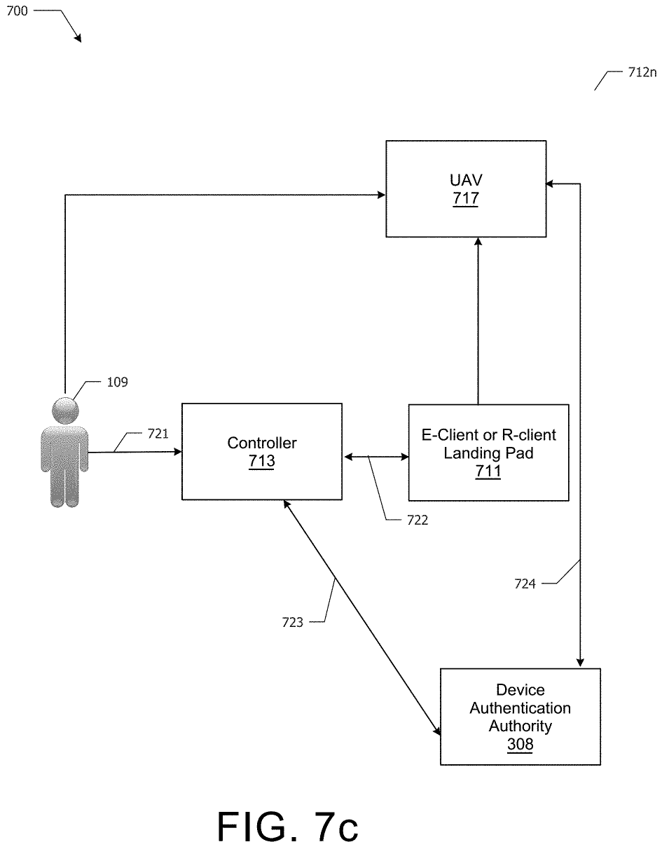

Every object on the DOS, SDAS, and USSN systems as an embodiment is a “node” and every node has the following equipment: 4G, 4G LTE and 5G LTE antenna(s), WiFi antenna, Raspberry Pi or similar SoC computer that can be programmed, a flash card for storage, an IP identifier, Remote ID, and serial number such as a smart drone landing pad and charging station that shall have an address that matches the physical address of the fixed, stationed landing pad. A “Node” can be any hardware and or software on the system. It can be meteorology equipment on the UAS Rooftop and Ground Airport or a hard drive on or in a Smart Drone Mailbox Landing Pad, in any configuration of a C-Client, E-Client, M-Client and or M-Sub Client. Additional details regarding the nodes and their respective types is described in detail below in reference to FIGS. 7a-e. Every node will have the following characteristics: Node types consist of but not limited to the drone, battery, smart drone/UAV point-of-sale (POS), electronic vehicles, hybrid autonomous vehicles, fully autonomous vehicles, smart drone rooftop and ground airport system, smart mailbox landing pad and charging station, smart delivery container, smart charging/hanger station, smart landing pads, smart drone and landing pads, etc.; Sector types—will be for special-purpose applications like medical delivery or law enforcement, etc.; unique 160 ID encryption; public-private key pair; public-key certificate; primary status (available or unavailable); secondary status (additional details); event log; and schedule of commitments. Every node has access to the following services: NextGen weather data streams; ADS-B data exchange; GPS; drone flight planner (DFP); drone data exchange (DDE); drone system state (DSS); drone mission database (DMDB); device authentication authority (DAA); and drone mission checker (DMC). Individual nodes will publish status and event information to the DDE at regular intervals. From this, the current state of the entire system will be built and updated. Additional authentication throughout this process can simultaneously and or individually with no importance of order communicate in authenticated way to and for but is not limited to, pre-flight inspection, Remote Identification, No Permission No Take-Off (NPNT), and LAANCE. Users and customers have access to another service called the drone request system (DRS) through which they can hail services.

A drone flies the next of what may be multiple legs, waypoints and or vectors, of the mission. A) it consults its itinerary to see which node is next; B) it communicates in an authenticated way to ensure that the next node is ready for its arrival; C) as it arrives at another node, it updates its schedule of commitments and activity logs; D) if along the way, the drone finds that it must update its itinerary because a node that had been included is no longer available, it will ask the DFP to update the itinerary and the changes will be pushed to the affected downstream nodes; and E) when the drone arrives at the destination node, the delivery will be made, a notification to the smart doorbell will be wirelessly rang, with a text, messenger, and or push notification on a smart watch, smart phone, smart tv, and or online will be given to the end user will authenticate the receipt of the delivery via mobile app, mobile phone, biometric identification, wand, and or any other authentication means, the drone will open the smart container, smart mailbox landing pad or smart parcel mailbox landing pad, the receiving party, smart parcel mailbox landing pad or smart parcel mailbox landing pad will close the container or accept the disposable container, the drone missions database (DMDB) will be updated to record the finished mission, and the drone will either charge there or move on to a recharge station if the destination is not capable of recharging the node or head to the next mission if capable.

Weather, traffic, ATC, TFR, etc., causes a denial for UAS flight-should the UAS delivery not meet the permissions which provide an authentication for flight, the controller will provide for the following options by redirecting action to the vehicle fleet management (VFM) operating system module which offers four services: 1) Vendor in-house manned vehicle delivery service; 2) SDAS in-house autonomous unmanned ground vehicle (UGV) hailing service; 3) third-party manned vehicle API app hailing service; 4) third-party autonomous unmanned ground vehicle (UGV) hailing service using a third-party API app. A UAS Flight that has not given permission or has flown en route to an out of the NAS authorized envelope for its destination, will allow for a handoff directly to the ATC, Tower, and or anyone within the National Airspace (NAS) Controlled area which may manually take over the UAV through a No Permission No Take-Off (NPNT), No Permission No-Landing (NPNL) handoff from the DOS to the NAS Controller where and if necessary. Otherwise, it will remain in the manual control of the DOS. Once unauthorized fight is controlled, it will be handed back to the DOS.

For an example of a smart mailbox landing pad and charging station 101, the following nodes are utilized. If the smart drone mailbox landing pad and charging station is on the Drone Ground Airport, it is a C-Client for Smart Drone Mailbox Landing Pad and Charging Station that is External, but on a Ground Smart Drone Airport. If the smart drone mailbox landing pad and charging station 101 is anywhere away from the Smart Drone Rooftop and Ground Airport 102, it is a M-Client for a Smart Drone Mailbox Landing Pad and Charging Station that is external from the Smart Drone Rooftop and Ground airport 102.

Additionally, the C-Client and M-Client Smart Mailbox Landing Pad and Charging Station(s) 101 may have Sub-categories that are for peripherals that are able to be monitored as modulated, scalable and or interoperable hardware and software. These Items will be called M-Subcategories.

FIG. 3b shows an example embodiment of an Unmanned System Service Network (USSN) 300 utilized by systems according to the present invention. The USSN 300 for the smart drone rooftop drone-port/airport is used to enable the communications necessary to support a robust drone or unmanned aerial vehicle (UAV), unmanned ground vehicle (UGV) or vertical take-off and landing vehicle (VTOL), etc. facilities. The USSN 300 has been designed to achieve the following goals: A) flexibility:—the network is agnostic and can support a wide variety of data communications and platforms such as DaaS, IaaS, PaaS, SaaS, RaaS, and C-RAN, allowing for open platform integration and SDK software development; B) extensibility-new kinds of devices and components can be integrated into the network readily and inexpensively; C) security-all communications will be encrypted for confidentiality and signed so that components will authenticate themselves to the USSN and to each other; and D) performance-data exchange will occur efficiently when and where it is needed so that components can perform their intended functions. Remote ID authentication of all “Node” components will be required throughout the process as and when needed.

The USSN 300 utilizes the drone flight planner (DFP) 302, drone request system (DRS) 303, a drone system state (DSS) 304, a drone mission checker (DMC) 305, a drone mission database (DMDB) 310, and a drone authentication authority (DAA) 308. The customer requests service from the DRS 303 which asks the DFP 302 to plan a flight. The DFP 302 sends the origin and destination to the DSS 304 which responds with the status information of candidate nodes for the mission. The DFP 302 invites nodes to be part of a mission via the DAA 308 which sends an authentication message to the nodes which may accept or reject the invitation which may be returned to the DFP 302. The DFP 302 may then transmit a confirmation to the DAA 308 which passes the confirmation to the nodes. The DFP 302 logs the flight in the DMDB 310 and the nodes send status changes to the DAA 308 which forwards the status changes to the DSS 304. The DSS 304 sends status changes to the DMC 305 to determine if any active missions must be updated. The DMC 305 queries the DMDB 710 to help it identify affected missions, and if missions are affected, the DMC 305 transmits a request to the DRS 303 to launch a drone flight modification request to repeat the process. The drone system services network provides flexibility, extensibility, security, performance and scalability to the drone airport system.

USSN Architecture. The USSN 300 consists of nodes and there are three types of nodes from the original filing and two additional types of nodes added for the smart drone mailbox landing pad and charging station: controllers (C-Client), smart drone rooftop and ground airport clients (R-clients), extended external clients (E-clients) that are not on the smart drone rooftop or ground airport, smart drone mailbox landing pad and charging station clients (M-Client) that are extended and external from the smart drone rooftop and ground airport, and smart drone mailbox landing pad and charging station sub-category clients (M-Sub Clients) that are components on or within the extended and external smart drone mailbox landing pad and charging station. Each smart drone rooftop drone port/airport will employ one or more controller node(s) if necessary and as many client nodes as the rooftop can accommodate based on government compliance and class approvals. The controller provides services to the client nodes and serves as the smart drone rooftop airport's central point of contact. The controller node sends commands and configuration information to the client nodes and receives data and service requests from them. The controller and client communicate with each other over a TCP-IP and or Wi-Fi Network. The controller node communicates with devices beyond the rooftop using a 4G, 4G LTE, or 5G mobile data network.

USSN Controller Node Architecture. The controller node consists of an Internet-connected computer, authentication fob, GPS transmitter, and mobile network antenna. The computer and authentication fob are housed in a theft-proof, environmentally hardened container. The authentication fob is a USB key containing the controller's 160-bit identification number (ID) and private RSA key. The controller runs a modern commercial-grade operating system that hosts the following: 1) a Wi-Fi router with managed IP address assignment; 2) a web server configured with the controller's public key certificate; 3) a database server; 4) a web application featuring a RESTful API, through which R-clients, E-clients, M-Clients and or M-Sub Clients, may request reservations, data and other services; 5) an event logger; 6) a fees ledger for keeping track of takeoff and landing fees to collect; 7) an R-client, E-clients, M-Clients and M-Sub Clients, inventory tool used to keep track of the R-clients, E-clients, M-Clients and M-Sub Clients that the controller manages; and 8) an R-client, E-clients, M-Clients and M-Sub Clients messenger tool for communicating instructions and data with R-clients, E-clients, M-Clients and or M-Sub Clients.

USSN R-Client Part 1. An R-client is located on the rooftop with the controller. R-clients include non-optional and optional modular features from both the provisional patent filing incorporated herein, plus the integration options of: Rooftop Landing Pads, Rooftop Landing/Charging Stations, Rooftop Storage-Charging-Deicing-Hanger Stations, Rooftop Delivery Storage Containers, Hail Pads, Rooftop Quick Change UAS Battery Stations, Air Navigation Service Provider Devices (ANSP) Systems, 4G, 4G LTE, and 5G Air to Ground and Air to Air Systems, Next GEN Weather Station Systems, Weather Data Equipment and Collection hubs (Anemometer, Thermometer, Barometer, Digital Rain Gauge, Lightning Detector, Automated Weather Observing Systems (AWOS), Automated National Weather Service (NWS) Data, Low Level Wind Shear Alert System (LLWSAS), Low Level Wind Shear Alert System Network Expansion, (LLWAS NE), Automated Surface Observing System (ASOS), Automated Weather Sensor System (AWSS), WakeTwbulenceEquipment, LowLevel Wind Shear Advisory System (LLWAS), Runway Status Lights (RWSL) systems for runway and taxi way lighting, Runway Entry Lights (REL), Take-off and Hold Lights (THL), Line-Up and Wait Lights (LUAWL), Low Intensity Runway Lights (LIRL), Airport Surface Detection Equipment (ASDE), ASDE-X (Model X) using radar, multilateration and satellite, and LGA ASDE for manned and unmanned UAVs, VTOLS, and eVTOLs, Airport Surveillance Radars (ASR-9), En Route Automation Modernization (ERAM), NextGen Air Transportation System, with PDC-Pre Departure Clearance and UAS Low Altitude Authorization and Notification Capability (LAANC) Automated Clearance, 4-Cube, User Request Evaluation Tool (URET)—which checks continuously for aircraft and unmanned aircraft midair conflicts between other aircraft and unmanned aircraft by evaluating the time before conflict, conflict configuration to estimate the probability that the situation will develop into a close approach then notify a sector if needed with 10 to 20 minute notifications ahead of time using its predictive statistics, X-terminals, D-Controllers, Automated En Route Air Traffic Control (AERA), Seek and Avoid Equipment, Required FAA Remote ID Transponder/Sensors (Such as ADS-B, C-Mode, S-Mode, M-Mode, etc.), Wide Area Augmentation System (WAAS), Center Weather Service Unit (CWSU), North American Route Program (NRP) for SID, STAR, Canned Waypoints, Departure (PITCH) and Arrival (CATCH), Reduced Vertical Separation Minimum (RVSM) and Non-Vertical Separation Minimum (Non-RVSM) equipment, Artificial Intelligence and Machine Learning Autonomous Automation Equipment, Performance Based Navigation (PBN) such as RNAV Standard Instrument Departures (SID), Standard Terminal Arrival (STAR), T-Routes (Terminal Routes), Q-Routes (Using Waypoints), V-Routes (Vector Airways), and J-Airways (Jet Airways), Distance Measuring Equipment (DME), Manual and or Automated Air Route Traffic Control Center (ARTCC) for national transportation, Traffic Management System, Ground Navigational Aids (NAVAIDs) such as ILS, VORAC, VOR, and NDB, Global Navigation Satellite System (GNSS) such as Receiver Autonomous Integrity Monitoring (RAIM), Ground Based Augmented System (GBAS), Global Positioning System (GPS), and Satellite Base Augmented System (SBAS), Approach Control Facilities, Airport Traffic Control Tower (ATCT), Automated Terminal Radar Approach Control (TRACON/ATRACON) for manned and unmanned aviation, Fight Services with Automated Aircraft, UAVs, eVTOLs and VTOL Collision Separation (Longitudinal, Vertical, Lateral), Minimum Vectoring Altitudes (MVA), and separation between Aircraft, UAVs, eVTOLs and VTOL and protected airspace, Airport Surveillance Radar (ASR-9/11) for an integrated primary and secondary Digital Radar, Minimum Safe Altitude Warning System (SAWS) for Conflict Alerts (CAs), Ceilometer, Automated Sectional, Terminal, Low Altitude IFR and High Altitude Aeronautical Charts hardware and software for manned and hybrid fight, Virtual Approach Gates, Airport Noise Management System (ANMS) for aircraft, UAV, VTOL, eVTOL, noise and noise monitoring abatement for Day-Night Average Sound Level (DNLs), Sound Exposure Levels (SELs), OMP Build Out Noise Contour (BNC), Frequency Hopping Spread Spectrum Radio (FHSS), Code Division Multiple Access (CDMA), RADAR, Light Detecting and Ranging (LiDAR), Infrared, Sonar Object Detection Device (SOD), Radio Frequency Device (RF), Radio Frequency Identification Devices (RFIDs), Static and Dynamic Quick Response Devices (QR Codes), Solar Panels, Active Digital Distributed Antenna System (DAS), Near Field Communication Antenna (NFC), Wireless Fidelity Wireless Internet System (WiFi), WiFi router, 4G, 4G LTE and 5G Devices, Global Positioning Transmitting System (GPS), Global Air Traffic Surveillance System Devices (GATSS), Inertial Reference System Devices (IRS), Unmanned Aerial System Service Supplier (USS), International Mobile Subscriber Identity (IMSI), Anti Catchers (Cell Tower Simulators) Systems, Wide Area Augmentation System (WAAS), NFC antenna, Bluetooth Antenna, Low Wind Antenna, C RAN Antenna System, Massive MIMO, Common Public Radio interfaces (CPRI), Baseband Unit (BBU), Base Station, Base Transceiver System (BTS), Coordinated Multi Point (CoMP), Beamforming Hardware, Transport Extension Nodes (TEN), Central Area Nodes (CAN), Carrier Access Point (CAP), Wide Area Integration Node (WIN), Voltage Standing Wave Radio (VSWR), Wireless Broadband, WiMAX, Zigbee Wireless Devices, Spectrum Access Systems (SAS), Multi-Tenant Data Center (MTDC), Citizens Broadband Radio System Device (CBRS), CUAS/CUAV, (Counter Anti-Drone Devices), Anti EMP Devices, Internet of Things Devices (IoT), Dedicated Short Range Communication Devices (DSRC), Drone to Drone Communication Devices (D2D), Drone Landing Pad Communication Devices (D2L), Drone to Infrastructure Communication Devices (D2I), Drone to Drone Single Hop Broadcasting Devices, Drone to Drones Multi Hop Broadcasting Devices, Drone Platooning Devices, Sensors, Intelligent Lighting, Blockchain Devices, Telemetry Devices, Sky Cameras, Security Cameras, Vision Process Systems (VPS), Real World Interface (RWI), Extended Kalmen Filter (EKF), Simultaneous Localization and Mapping Devices (SLAM), Fast Lightweight Autonomy System (FLA), Random Sampling Consensus Devices (RANSAC), Laser Scanner, US Data Exchange Devices (USDE), Low Altitude Authorization and Notification Capability Devices (LAANC), Urban Air Mobility Eco System Devices (UAM), Real Time Locating System (RTLC), Asset Tracking Label System Devices (ATL), Barcodes, Servers, Auxiliary Energy Systems, Unmanned Traffic Management Devices (UTM), FANS 1, FANS 1/A Systems, FANS Router, FAN enabled Avionics, Edge Computing Systems, Cloud Systems, Multi Cloud Systems, Local Cloud Systems, Distributed Cloud Systems, Hybrid Cloud Systems, Compute Edge, Device Edge, and Sensor Edge Systems, Machine Learning Systems, Augmented Reality (AR) Nirtual Reality (VR)/Mixed Reality (MR) Systems, Artificial Intelligence (AI) Systems, High Performance Networking (HPN) Systems, Predictive Maintenance Systems, Asset Optimization Systems, cognitive analytic systems, Industrial Internet of Things (IoT) Automation Systems, Digital Operations Systems, DigitalOps Systems, DigiOps Systems, VMWare Systems, and Public and Workforce Safety and Efficiency Systems.

USSN R-Client Part 2. Satellite Based Augmented System (SBAS) integration modulation that supports Wide Area or Regional Augmentation Worldwide: A) North America-Wide Area Augmentation System (WAAS); B) Europe-European Geostationary Navigation Overlay Service (EGNOS); C) Japan-Multi-Functional Satellite Augmentation System (MSAS); D) India-GPS Aided Geo-Augmentation Navigation (GAGAN). The technology is a critical component of the FAA's Next Generation (NextGen) program and the EUROCONTROL SESAR initiative. “Upgrading” to SBAS involves replacing an existing flight management system (FMS) with a new SBAS-capable FMS. As an in-line replacement, the Universal Avionics SBAS-FMS constitutes minor changes to wiring, antennas, keying and configuration when certified for most LPV capabilities. Still, most of the existing wiring may be used. Non-LPV SBAS-FMS installations have lesser changes. However, direct installation of an SBAS on a UAS rooftop airport allows for use of the FAA's NextGen with no upgrading.

USSN R-Client Part 3. SBAS allows for national air space (NAS) integration of aircraft and helicopter transportation with UAS, UAV, VTOL, eVTOL, CTOL, STOL, heliport, vertiport, rooftop drone-port/airports integration modulation. Approved GPS position input sources in accordance with the appropriate TSO for integration with approved transponders for the ADS-B Out mandate compatible with SBAS around the world: WAAS, EGNOS, MSAS and GAGAN. This ensures compliance with precision-area navigation (P-RNAV). Key element of performance-based navigation (PBN) and required Navigation performance (RNP)/Area Navigation (RNAV). This allows for user-friendly use with more capabilities to reduce pilot workload for hybrid autonomous and manual pilots and increase flight operations efficiently for unmanned aircraft with every new universal avionics SBAS-FMS installation and major hardware upgrade. Enhanced safety provided with the latest TSOs more accurate SBAS and GPS information to the onboard TAWS/EGPWS and TCAS. This eliminates manual RAIM prediction requirements, incorporates high-speed ethernet technology that allows for faster data downloads via the Solid-State Data Transfer Unit (SSDTU). Low-level and high-level smart UAS, UAV, VTOL, eVTOL, rooftop and surface airports/vertiports and or integrated hybrid heliports, can provide for direct routing and direct approaches that eliminate the step-down type approaches. This will allow for shorter routing to secondary airports due to adverse weather conditions that will be provided by rooftop meteorology equipment and/or NAS available third-party services. Drones will be equipped with ADS-B to have the ability to receive traffic information, weather data, and flight information. Virtual airways that may be designated by the Department of Transportation, FAA and/or other government entities for drones will be integrated in USSN as a R-client virtual drone airway (VDA). The SDAS rooftop drone ports/airports will be able to seamlessly integrate with the key component of the universal avionics Future Air Navigation System (FANS) solution.

USSN R-Client Part 4. The FANS integration modulation will provide: A) an option for direct data link communication between the pilot, remote pilot and the air traffic controller (ATC); B) Aircraft Communications Addressing and Reporting System (ACARS) communications (satellite-based); C) Communication, Navigation, and Surveillance (CNS)/Air Traffic Management (ATM) for Air Traffic Service (ATS) providers; D) Data Link Service Providers (DSP)/Communication Service Providers (CSP). Radio or satellite technology (SatCom) issued to enable digital transmission of short, relatively simple messages between the aircraft, UAS, UAV, VTOL, eVTOL, CTOL, STOL, heliports, vertiports and ground stations. Communications typically include the traditional air traffic control clearances, pilot requests, and position reporting. The goal of FANS is to improve performance related to communication, navigation and surveillance (CNS)/air traffic management (ATM) activities within the operation environment. Through a satellite data link integration feature, airplanes, drones, UAS, UAV, VTOL and eVTOL equipped with FANS can transmit Automatic Dependent Surveillance (ADS) reports with actual position and intent information at least every 5 minutes. This can provide for real-time en route and re-route AI weather reporting from FANS and NextGen to and between airplanes, drones, UAS, UAV, VTOL and eVTOL aircraft.

USSN R-Client Part 5. Additional integration modulation for observation, prediction, UAS, UAV, VTOL, eVTOL, CTOL, STOL deployment and third-party services, that will be available with the assistance of UAS/UAV, VTOL, eVTOL, CTOL, STOL, meteorological, networking, and operating systems equipment on the SDAS drone-port/airport: A) information disseminated from the drone equipped with a drone anemometer and/or barometer and/or IMU, in order to create Drone Aircraft Reports (AMDAR) that were deployed from the SDAS drone-port/airport. Common Support Services-Weather (CSS-Wx)—Which publishes info provided by the NextGen weather processor and use of the System Wide Information Management Network to the FAA and National Airspace System (NAS); B) Observations through the following: NextGen CCS-Observations-Satellite Imagery; Radar Imagery; Aircraft Reports (AMDAR); Surface Reports (METARS); Upper Air Reports (Balloon Soundings); Numerical Modeling; Statistical Forecasting—NWS Forecasters, Auto Forecast System and Forecast Integration; CoSpa: Consolidation Storm Prediction for Aviation; Storm Prediction Center (SPC); Drone Weather Avoidance Field (WAF and UASWAF) Module—with Drone Deviation Model and Forecast Drone Avoidance Regions Models; Vortex 2 and 3—for Weather Chasing and Reporting with Drones; National Severe Storms Laboratories (NSSL); and Drone In-house, Mesonet and or other third-party drone fleet data sharing; and other smart devices that collect data and send it to the controller and that may receive instructions from the controller.

USSN R-Client Hardware. Each R-client includes as part of its hardware the following: 1) a system-on-a-chip (SoC) computer, such as a Raspberry Pi, that is equipped with a WiFi Antenna; 2) a USB key that includes the R-client's 160-bit identification number and private key; 3) an R-client configuration manager that holds the 160-bit ID and public key of the controller; 4) an R-client messenger tool for communicating instructions and data with the controller; 5) a Wi-Fi router, NFC antenna, and or Bluetooth Antenna to communicate with other R-clients or, for Small Landing Pads/Smart Mailbox and Parcel Landing Pads, Smart Charging Stations, Hangers, HeliPort, VertiPorts for Drones (UAS, UAV, VTOL, eVTOL, etc.), that land on it.

USSN E-Clients. An E-client is any remote device or application that requests or uses the services of the rooftop airport. Examples of E-clients include in-flight UAVs, POS systems, take away delivery apps, API and SDK apps, flight-hailing apps, public safety systems, Amber Alert systems, first responder systems, blockchain systems, cyber security systems, weather-reporting systems, and logistics operators. E-clients communicate with controllers to request services, request data, provide data, arrange flights, and coordinate landings.

Installing an SDAS rooftop drone-port/airport 300. The controller maintains an inventory of R-clients. R-clients include rooftop landing pads and other equipment discussed hereinabove associated with the drone services that share the roof To install a new R-client the rooftop operator will: I) register the R-client's 160-bit ID in the controller's R-client inventory system; 2) register the controller's ID and public key with the R-client's configuration manager; 3) assign the R-client a fixed IP (Remote ID) address through the controller's WiFi router; and 4) install the R-client messenger tool on the R-client and configure it to communicate with the controller.

Reserving and Implementing a Takeoff Part 1. A remote requestor uses a web browser or mobile app to connect to the controller's reservations homepage. User, pilot and/or controller specifies “takeoff request” as the type of transaction, which of the controller's available drone models to schedule, destination GPS, and type of payload. The controller scans its inventory of available drones to identify a match. After asking for and receiving confirmation from the remote requestor, including payment of the fees associated with the takeoff, the controller, at the designated takeoff time, sends GPS coordinates of the selected UAV's destination to the UAV's host pad through the R-client messenger tool. The host pad communicates the GPS coordinates to the UAV, completes an automated and or manual pre-flight inspection, receives all necessary permissions for take-off, however, no permission, no take-off (NPNT), this should take and initiates the takeoff. The host pad notifies the controller that the takeoff occurred. The controller and or blockchain logs the event in its schedule and resets the R-client landing pad's status to available.

Reserving and Implementing Takeoff Part 2. A remote requestor uses a web browser or mobile app to connect to the controller's reservations homepage. I) S/he specifies “takeoff request” as the type of transaction; 2) to which of the controller's available drone models to schedule, destination GPS, and type of payload; 3) the controller scans its inventory of available drones to identify a match; 4) after asking for and receiving confirmation from the remote requestor, including payment of the fees associated with the takeoff, the controller, at the designated takeoff time, sends GPS coordinates of the selected UAV's destination to the UAV's host pad through the R-client messenger tool; and 5) the host pad communicates the GPS coordinates to the UAV, completes an automated and or manual pre-flight inspection, receives all necessary permissions for take-off, however, no permission, no take-off (NPNT), this should take and initiates the takeoff. The host pad notifies the controller that the takeoff occurred. The controller and or blockchain logs the event in its schedule and resets the R-client landing pad's status to available.

USSN Other Data Requests. Besides landing pads, a rooftop may contain other R-clients whose services and/or data E-clients may request. For example, service providers may request low altitude weather data from NextGen weather measurement and data collection devices. To request data from R-clients, a would-be consumer will access the controller's web page to request the desired service/data set. It is up to the owner/configurator of the controller to decide which services to make available to which E-clients and to implement the communications needed to provide the service. Based on that configuration, the controller and R-client will coordinate fulfilling the E-client's request. The controller serves as the initial point of contact that authenticates and then fulfills the request, In-house and third-party APis and SDKs can be customized for customer needs as well.

USSN System Network and Cyber Architecture Platform. This is the entire platform integration of the: I) microservices platform agnostic; 2) cybersecurity reference architecture; 3) corporate data center; 4) AWS security or the similar security and cloud diagram; and 5) USSN node system hardware and software diagram.

All portable drone landing pads are a part of the infrastructure and shall have, in addition to the owner of record's address and Remote ID, the longitude and latitude quadrants and GPS location of the portable landing at the time of its request and use. In some embodiments, a flight plan, dispatch approval (manual and/or automated), and payload/cargo manifest will be digitally logged and uploaded via cloud computing systems known in the arts to all required authorities/agencies and/or vendor/servicer participants for any UAS/drone flight executed for service and or delivery. A friend and or family option will allow for multiple assigned and authorized users on one portable landing pad with a Master Remote ID and or Sub-Remote ID and or IDs for each authorized participant using the portable landing pad at the time of use period.

Up to two alternate routes may be provided by an algorithm and/or artificial intelligence (AI) for best in-route flight results based on all variables necessary and that can affect a safe UAS/drone flight, such as weather, traffic, availability, inoperability, unforeseen delays, no-fly zones, Temporary Flight Restrictions (TFRs), Geo Fencing Guidelines, Waypoint Restrictions, and the like. Upon confirmed matches of all above IP and physical addresses assigned to such owners of record via the UAS/drone operating system (DOS), the drone mobile and online applications, and any other means of consumer private and commercial public use and request may proceed with its routes.

The system 300 of FIG. 3b shows the USSN 300 supporting both a rooftop airport and charging station 102 as well as the smart mailbox landing pad and charging station 101 disclosed herein. With respect to these landing pad locations and their respective interaction with both drones 100 and the USSN 300, The processes perform similar functions associated with instructing an autonomous smart drone 100 to land and take off to perform deliveries. Where the smart mailbox landing pad 101 is envisioned to be located near individual destinations for packages of all types, the rooftop airport landing pad 102 accepts for landing and permits takeoffs for drones 101 before and after a delivery of a package is performed. In both cases, the Device Authentication Authority 308 authenticates and authorizes a particular smart drone 100 to takeoff, fly a route, and to land. The unique Remote ID for the drone 100 should be recognized as being permitted to use the various landing pads, as well as specifically intended to land at a given landing pad. Similarly the Device Authentication Authority 308 authenticates and authorizes a particular node associated with a specific landing pad to ensure that the smart drone 100 is intended to deliver a package to that particular mailbox. The Device Authentication Authority 308 implements a permission to fly protocol for drones and landing pads under its control. While a No Permission No Fly protocol is described herein as a preferred embodiment for a protocol used by the Device Authentication Authority 308, other protocols may also be implemented.

In some embodiments, SDAS smart drone landing pad stations 101 and rooftop UAS drone-ports/airports 600 will have an option that allows for weather descriptor codes to be relayed and translated by cloud computing automation and big data to the appropriate receiving location in need of it for important to automated flight decisions, data harvesting, mining, dissemination, and storing. Additional description of the USSN system 300 and its functionality is described within the parent application U.S. patent application Ser. No. 16/866,484, titled “SMART DRONE ROOFTOP AND GROUND AIRPORT SYSTEM,” and filed on May 4, 2020. This application is incorporated by reference herein. What is important to note is that any hardware or software that is necessary for use within this environment will be called a “node” and those nodes will be categorized by C, E, R, M, and M-Sub Clients. Interoperability allows for the continual modulation and scalability of any and all sensors, actuators, parts, software, equipment necessary for the operational use.

The Drone Airport System, via the DOS system, will integrate the Next Generation Air Transportation System (NextGen), an FAA-led project, focusing on development of a system designed to implement innovative new technologies and airspace procedures to improve safety, shown in FIG. 7c. By the integration of NextGen, CSS, 4-D Cube, and MIMO technologies in the aviation field with our Rooftop UAS/UAV/Drone Port/Airport(s), UAS/UAV/Drone(s) and our UAS/UAV/Drone Landing Pads and UAS/UAV Garage/Hanger/Charging Station, within the National Airspace System (NAS), Federal Aviation Administration (FAA) System, U.S. Postal System (U.S.P.S.), and Third Party Carrier Systems, our UTM DOS system is able to provide accurate and Al automated: 5G MIMO Network Communications, Layered Cyber Security Integration, UAS/UAV/Drone POS Land/Mobile System for Retailer and Consumer Order fulfillments, Satellite Weather and Traffic Data—for Real Time Weather and Traffic Decision Making (such as a Flow Constrained Area (FCA)).

In addition, the NextGen will also enable accurate and Al automated Traffic Control, GPS Ground UAS/UAV/Drone Detection, Satellite In-Flight Detection and Avoidance ofln-Flight UAS/UAV/Drones and or In-Flight Weather Avoidance Field(s)(WAF) that has been translated into Weather Constraints via NextGen ATM Weather Integration—from Order and Delivery—back to Home Base or Redirect, and for Al Automated Management of Multiple Grounded, Parked, Stored and In-Flight UAS/UAV/Drone(s)—having Transponders, Receivers and or Cellular Chips, both In-House and to Third Party System(s), Detection of Vacant, Pending, Committed, Decommissioned and or Occupied UAS/UAV/Drone's Drone Landing Pads, Garages/Hangers/Charging Stations.

The UTM DOS System will be able to transmit its own weather information and traffic data to the same systems and third-parties.

FIG. 3d is a graphical chart outlining integration of the smart city smart drone UAS, UAV, VTOL, eVTOL mailbox landing pad and charging station 101 into the Drone Industry System Corp's UAS/UAV/VTOL/eVTOL/HeliPort/VertiPort Rooftop and Ground Airport/Drone Port System(s, the Next Generation Air Transportation System (NextGen), the USS Service Supplier (USS), Air Navigation Service Provider (ANSP), the Low Altitude Authorization and Notification Capability (LAANC) (UAS Data Exchange), the Next Generation Air Transportation System (NextGen), an FAA-led project, Urban Air Mobility (UAM) Eco-System, the Satellite Based Augmented System (SBAS), the Global Air Traffic Surveillance System (GATSS), both NASA and or FAA-led project(s), IoT and Telemetry, focusing on development of a system designed to implement innovative new technologies and airspace procedures to improve safety, in accordance with an exemplary embodiment of the present invention. True Last Mile Logistics (TLML) can also be achieved through this system. As shown in FIG. 3d, the Smart Mailbox Landing Pad and charging station 101, via the DOS system, will integrate, including but not limited to, the CSS, 4-D Cube 320, and MIMO low latency technologies, and the Next Generation Air Transportation System (NextGen), an FAA-led project, focusing on development of a system designed to implement innovative new technologies and airspace procedures to improve safety.

By the integration of NextGen, CSS, 4-D Cube 320, and MIMO technologies in the aviation field with our Smart Drone Rooftop and Ground UAS/UAV/VTOL/eVTOL Airport(s)/Drone Port(s), UAS/UAV/VTOL/eVTOL Drone(s) and our Smart UAS/UAV/VTOL/eVTOL Drone Landing Pad(s) and Charging Stations, and Smart UAS/UAV/VTOL/eVTOL Garage/Hangar/Charging Station, within the National Airspace System (NAS), Federal Aviation Administration (FAA) System, U.S. Postal System (U.S.P.S.), Third Party Carrier Systems, and ground Logistic, Supply Chain Logistics and Telemetry Systems, our UTM DOS system is able to provide accurate and AI automated 5G, 4G, and or 4G LTE as well as scalable to the next generation(s) such as 6G, etc., MIMO Network Communications, Layered Cyber Security Integration, Smart UAS/UAV/Drone POS Land/Mobile System for Retailer and Consumer Order fulfillments, Satellite Weather and Traffic Data—for Real Time Weather and Traffic Decision Making (such as a Flow Constrained Area (FCA)), Block Chain Management, Block Chain Logging, Block Chain Ledgering, Block Chain Recording, and Block Chain Data Mining.

FIG. 3d shows the 4-Dimensional (4-D) Weather (Wx) Cube 320, incorporated into the cloud-based operating system of the smart city Smart Drone UAS/UAV/VTOL/eVTOL Mailbox Landing Pad and Charging Station 101, enabling continuously updated weather observations (surface to low Earth orbit, including space weather and ocean parameters), high resolution (space and time) analysis and forecast information (conventional weather parameters from numerical models), designed to predict various aviation parameters (icing, turbulence, wind, visibility, wind gusts, low level wind shears, humidity, temperature, and other weather anomalies), in accordance with an exemplary embodiment of the present invention. Each Smart Drone Mailbox Landing Pad and Charging Station 101 will be broadcasting to the Drone Airport System 300, the information regarding the surrounding weather conditions, and at the same time, the system will collect the data requested by the end-user via the mobile app. A plurality of Smart Drone Mailbox Landing Pads and Charging Station 101 broadcasting the same information will form a network, which may be integrated with the Drone Airport System (DAS), the NextGen Air Transformation System, and the 4-Dimensional (4-D) Weather (Wx) Cube 320, as shown on FIG. 3c.

The 4-Dimensional (4-D) Weather (Wx) Cube 320, is incorporated into but not limited to the DAS Weather Module, enabling continuously updated weather observations (surface to low Earth orbit, including space weather and ocean parameters), high resolution (space and time) analysis and forecast information (conventional weather parameters from numerical models), designed to predict various aviation parameters (icing, turbulence, wind, visibility).

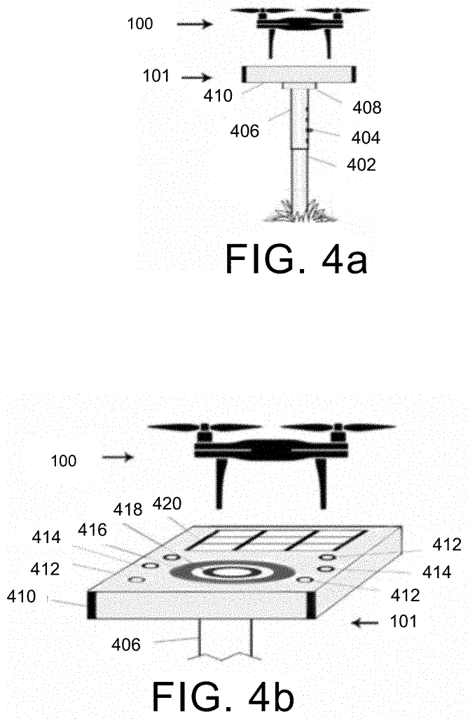

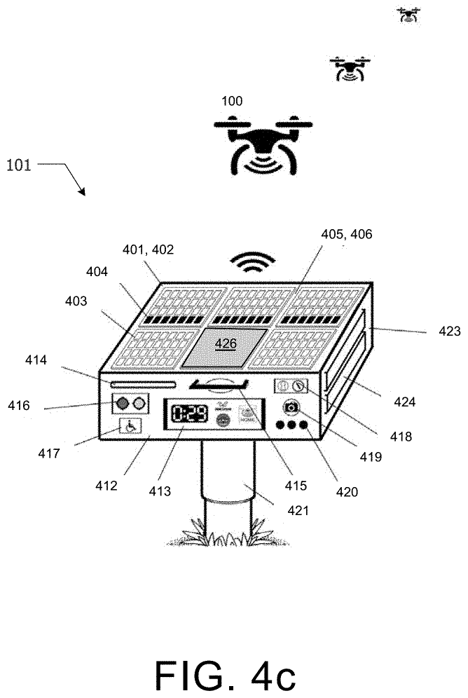

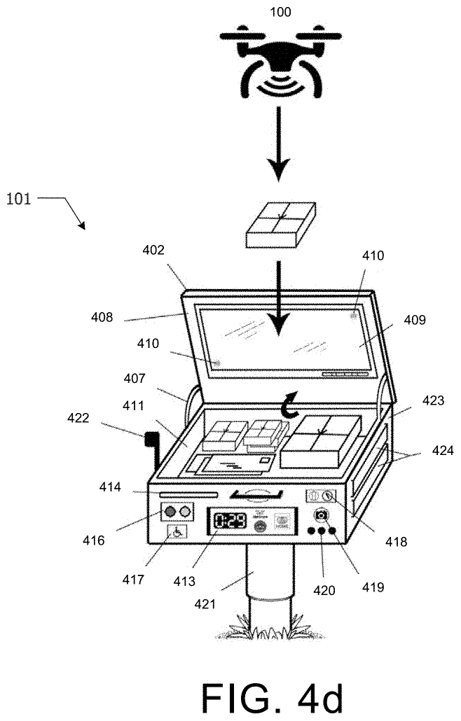

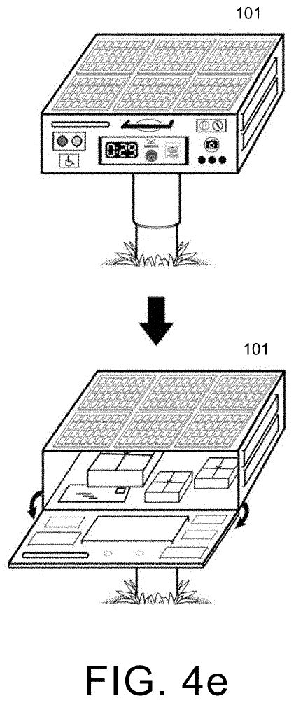

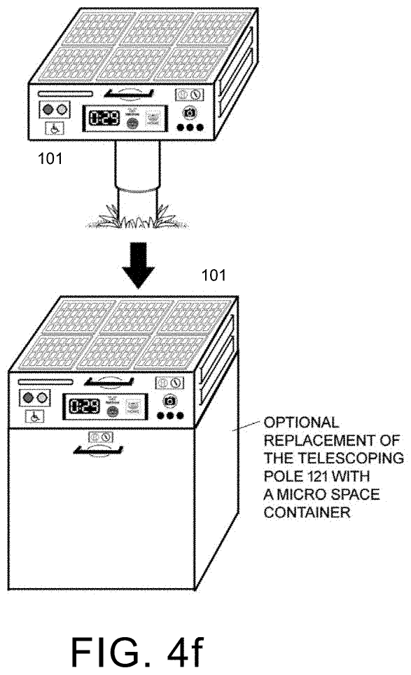

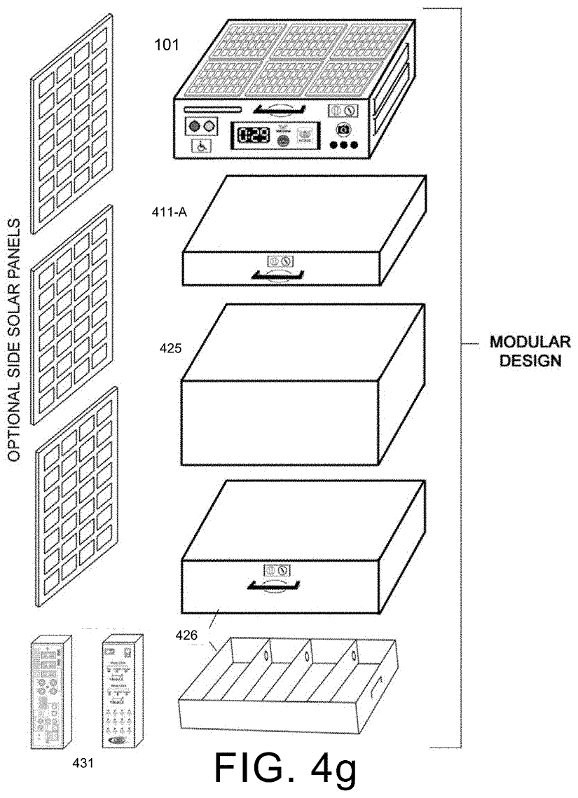

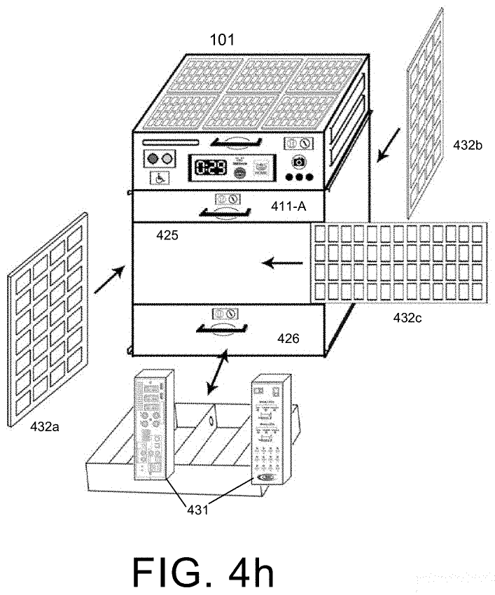

FIG. 4a-h illustrate example embodiments of a smart mailbox landing pad and charging station for use in package perishable and non-perishable delivery to a customer according to the present invention. FIGS. 4a-b illustrate an example embodiment of a smart drone mailbox landing pad and charging station 101 for a system providing smart modular containers (permanently fixed on the drone and or a leave behind container packaging) used by drones, smart drones and drone charging and or launching stations, smart drone charging and or launching stations according to the present invention. The autonomous flying devices 100 travel from vendor establishments to customers to deliver items that have been ordered for delivery. The autonomous flying devices 100 land upon a landing pad assembly 101 in order to permit customers to retrieve purchased items from within an attached container of the autonomous flying devices 100.

FIG. 4a shows a non-descriptive UAV vehicle 100 hovering directly above the landing pad assembly 401. The landing pad assembly 101 is mounted to the ground utilizing a support tube 402 in accordance with the present invention. The assembly 101 includes a support tube 402, quick release pin 404, telescoping tube 406, tube to pad adapter 408, landing pad assembly 410, landing sensors 412, beacon lights 414, near field communication (NFC) transmitter/receiver 416, wireless fidelity/wireless internet (WiFi) system 418, and solar panel 120.

FIG. 4b shows a non-descriptive UAV vehicle 100 hovering directly above the landing pad assembly 410. Moreover, the figure shows the top surface of the landing pad assembly 410, displaying its functional features. Imbedded into the assembly 410 is a solar panel 420 designed to provide the assembly 410 with uninterrupted electrical power. When functional, the landing pad 410 utilizes the imbedded NFC transmitter/receiver 416 and the built-in WiFi 418 systems to establish the radio data communication with the incoming UAV 100. These systems are designed to guide the incoming UAV 100 to the landing pad 410 utilizing GPS. Upon approach to the landing pad 101, the UAV 100 can rely on the landing pad's 410 built-in landing sensors 412 and the beacon lights 414 to guide it to the final landing position. The entire process is controlled/monitored by the end-user via readily available electronic devices, such as smart phones, tablets, laptops, desktops, smart watches, mind control head gear, and or smart tv's.

The landing pad 410 was also designed with various public facilities and government agencies in mind. Accordingly, the landing pad 410 can be easily adapted for use on military installations, law enforcement facilities, airports, schools, hospitals and various other public properties. The landing pad 410 can be attached to a top surface of any existing structure, or by utilizing the tube to pad adapter 408 as shown in FIG. 4a.

The landing pad assembly 101 depicted in FIG. 4a, shows several new improvements applicable to both a portable version of the landing pad 101 and a stationary version of the landing pad 101. The first improvement addresses the existing solar panel unit 120 of the landing pad 101. As described in FIG. 4a, the solar panel 420 was primarily designed to charge the landing pad 101 and its internal systems. These systems, specifically the WiFi communications system 418, the landing pad sensors 412, and the beacons 414, assist the drone 100 in locating the landing pad 401 and provide guidance during the landing process. The new solar panel 420 will not only provide the energy for the internal systems of the landing pad 101, but it will also serve as a charging station for any drone 100 utilizing the landing pad 101 itself It is important to note that the landing pad assembly 101, both portable and stationary, is not strictly dependent on the solar panel 420 for its power supply. Inductive Charging Pads will also be a choice of wireless charging that simply requires the drone to land on the inductive charging pad and immediately begin charging, which may use Qi Standards (the wireless standard for inductive charging) wireless drone charging. The smart landing pad and drone or smart drone, may use either or a hybrid of the two energy sources. The landing pad 101 may also draw its power directly from the nearby source of alternating current (A/C) and or Direct Current (D/C) by utilizing an optional power cord. If the alternating current is not available, the landing pad 101 may draw its power from an optional, portable battery pack supplying an appropriate level of direct current to power the assembly and its components. The combination of all or two or more of these power sources may also be used simultaneously if and when needed by direct use and or convers10n use.

FIG. 4c shows the Smart Drone Mailbox Landing Pad's and charging station's operation features including a digital touch screen 413, three-access points (envelope slit 414, top lid 402 and front door 412 that can either be scaled up or down based on custom order modulation), solar panels 403, induction charging pad 426, water drainage and de-icing channels 405-406, mail flag 422, automated and or manual handicapped mode 417, for telescopic height and door(s)/hatch(es) mode, motion and environmental sensors, telescoping pole 421, external and internal cameras 419, as well a plurality of options, including but not limited to side solar panels 424, portable systems drawer, inductive charging pads 426, hand held remote controls, and micro space containers. Solar panels are modular and can be exchanged for direct power. (AC and or DC).

The touch screen can be used for manual operation of the Smart Drone Mailbox Landing Pad and charging station 101, which means the end-user may, without the mobile app, operate all internal/external features of the Smart Drone Mailbox Landing Pad 101. The touch screen implements, and utilizes fingerprint capabilities, retina reading function, and drone identification numbers and Remote IDs to enable anyone's access to the Smart Mailbox Landing Pad and Charging Station 101, including the ability to open the front door 412, or the top lid 402 of the Smart Drone Mailbox Landing Pad and Charging Station 101. Once the top lid 402 of the Smart Drone Mailbox Landing Pad and Charging Station 101 is opened, the end-user may use the large monitor, attached to the internal surface of the top lid, to control the features of the Smart Mailbox Landing Pad 101. Here, the end-user can monitor the incoming parcels, and may review the collected data.

The internal monitor also implements two video cameras. The cameras provide an overview of the internal contents of the Smart Drone Mailbox Landing Pad and Charging Station. The cameras functionality is accessed via the mobile app. and may be used to confirm the delivery of a specific parcel. The external camera, attached to the front door of the Smart Drone Mailbox Landing Pad and Charging Station 101, is designed to provide the end-user with a view of the outside, or the surrounding area of the Smart Drone Mailbox Landing Pad and Charging Station 101. Once again, the end-user via the mobile app. will be able to review the weather conditions, and if necessary, confirm which individuals approached, touched or delivered mail to the Smart Drone Mailbox Landing Pad and Charging Station 101. The external camera will also provide the end-user with a visual confirmation of drones landing, charging, and departing, the Smart Drone Mailbox Landing Pad and Charging Station 101. As well as act as a security feature that the end user may view by mobile ap a live and real time stream of anything that moves and activates the camera or by personal manual use from the Smart Drone Mailbox Landing Pad and Charging Station 101.

Moreover, to ensure precise synchronization of movement between the drone and the Smart Mailbox Landing Pad and Charging Station 101, the system incorporates a wide variety of flight directing and controlling systems, including but not limited to the global positioning system (GPS) 401, geo-tracking system, object tracking system, autonomous take-off and landing support system, precision landing functions, light detection and ranging (LiDAR), positional sensors, Virtual Reality, Augmented Reality, Mixed Reality, flight routing and re-routing system, and the external vision and sensor systems.

FIG. 4d shows drone deliveries of items exceeding the internal capacity of the collection cavity, will be disposed on the top lid of the Smart Drone Mailbox Landing Pad and Charging Station 101. The weight of the package can allow for the inside base of the packaging floor to push down further to accept additional packages by assessing the weight with a spring and or automated hydraulic in order to lower the base of the packaging floor to accommodate the additional packaging of the Smart Drone Mailbox Landing Pad and Charging Station 101. These deliveries utilize reusable and fixed non-reusable temperature-controlled perishable foods, pharmaceutical, lab testing, vaccines, and non-perishable, etc., smart delivery containers; therefore, they do not rely on the temperature controlling systems of the Smart Drone Mailbox Landing Pad and Charging Station 101. However, the said reusable and fixed non-reusable temperature-controlled perishable foods, pharmaceutical, lab testing, vaccines, and non-perishable, etc., delivery containers, similarly to the modern cell phones, may utilize the charging capabilities of the Smart Mailbox Landing Pad and Charging Station 101, once the reusable and fixed non-reusable temperature-controlled perishable foods, pharmaceutical, lab testing, vaccines, and non-perishable, etc., smart delivery container makes contact with the top lid the Smart Drone Mailbox Landing Pad and Charging Station 101.

Additionally, regular parcel deliveries, thus parcels not requiring temperature-controlled environments, will be delivered via drones by placing said parcels inside the collection cavity. The drones 100 carrying the parcels will continuously communicate with the Smart Mailbox Landing Pad and Charging Station 101. Upon approach, the Smart Drone Mailbox Landing Pad and Charging Station 101 will open the top lid, enabling the placement of the parcel inside the collection cavity. Also, the drone 100 delivering the parcel may signal the need to recharge its batteries. If the process of recharging drones 100 has been permitted via the app. by the end-user, the drone will signal the Smart Drone Mailbox Landing Pad and Charging Station 101 to close the top lid, allowing the drone to gently land on the top, thereby initiating the process of recharging the batteries. The smart drone, drone or drone and smart drone deliver container may also be placed direct on the top of the closed Smart Drone Mailbox Landing Pad and Charging Station 101, where notification of delivery will require the end-user to come out, confirm their identity and order, automatically open the door of the smart delivery container, then take the detached delivered reusable container or open the fixed non-reusable smart delivery container and take the perishable and or non-perishable item(s) out of the smart delivery container, whereby the smart delivery container door will automatically open and the drone will leave to its next destination.

The Smart Mailbox Landing Pad and Charging Station 101 will draw its power from the solar panels, located on the top lid, or from other auxiliary solar panels, or from the inductive charging panel, which may be attached to the top and or the side walls the Smart Mailbox Landing Pad and Charging Station 101. The Smart Mailbox Landing Pad and Charging Station 101 may also be connected to a direct source of AC current, which in turn will be converted to DC current, and used for recharging its batteries, and the batteries of the drones using the Smart Drone Mailbox Landing Pad and Charging Station 101.

Individuals wanting to deliver mail will have to open the front door and place their parcels inside the Smart Drone Mailbox Landing Pad and Charging Station's collection cavity, as shown in FIG. 4e. Envelopes may be placed inside through the envelope slit, also located inside the front door. The end-users, will be able to confirm the new delivery using the mobile app. or by looking at the package notice lights, disposed on the front door; wherein the red light indicates no new deliveries, and the green light confirms the existence of newly delivered mail, while a yellow light feature indicates delivery in transit to the Smart Drone Mailbox Landing Pad and Charging Station 101.

The Smart Drone Mailbox Landing Pad and Charging Station 101 utilizes a wide variety of support systems. The most basic support is a fixed pole, designed to firmly attach the Smart Drone Mailbox Landing Pad and Charging Station 101 to the ground. The alternative to the fixed pole is a telescoping pole, shown in Fig Sa. Using the mobile app., the end-user may set the telescoping pole to automatically adjust its height, and the height of the Smart Drone Mailbox Landing Pad and Charging Station 101 attached to it. The end-user may also preprogram the height of the pad to accommodate individual(s) revisiting the Smart Drone Mailbox Landing Pad and Charging Station 101. The automatic adjustment may also be set to rely upon the exterior camera, located in the front door; wherein said camera will scan the height of the approaching individual and automatically adjust the height of the Smart Drone Mailbox Landing Pad and Charging Station 101 to accommodate that individual. A remote control can also manage the heights for the end-user of the Smart Drone Mailbox Landing Pad and Charging Station. 101.

The fixed, or the telescoping mounting pole, may be replaced with a micro space container, shown in FIG. 4f. The end-user may rent the micro space to various entities interested in storing hardware, firmware, and APis used for aggregation and dissemination of data such as but not limited to Block Chain Mining, Logging, Ledgering, Recording or for Surface Weather Reporting Data. As shown in FIG. 4g, The Smart Drone Mailbox Landing Pad and Charging Station 101 comprises of several, function-oriented modular components 425-426, including but not limited to the mailbox landing pad, charging station, portable system drawer 425, micro container, collection cavity, optional side solar panels 432a-c and inductive charging panels. The side solar panels, shown in FIG. 4f, may be used to generate more operational energy, or to store the accumulated energy, which may be sold to the local power grid company. The modulated spaces within drawers 425-426 are not just for scalability and interoperability of the parts, hardware, and software. This additional space also may provide a housing of all the same with the option for a third party to rent space within the modulated system by using our hardware, software or their own. This usage would be a Smart Mailbox Landing Pad that can rent and or sell physical and or virtual software and or hardware modulation, container and storage space.

As with the side solar panels of FIG. 4h, the sides of the Smart Drone Mailbox Landing Pad and Charging Station 101 may be covered by removable panels 432a-c over other decorative materials, prefabricated and sold as panels, wherein these materials include but are not limited to brick, stone, wood, cement, carbon fiber, glass and or plastic. These sliding panels 432a-c are shown in FIG. 4h as adding additional solar panels become eclectically connected to the power within the Smart Drone Mailbox Landing Pad and Charging Station 101. Prefabricated decorative marketing and advertisement materials may be sold as panels where these materials include but are not limited to paper, cardboard, plastic, carbon fiber, wood, brick stone, glass, and or cement.

As disclosed herein, the smart mailbox landing pad and charging station 101 is considered a node that is part of the USSN 300 that may include processing elements that perform additional functions as contained within software downloaded into the node. With this ability to add software, the smart mailbox landing pad and charging station 101 may include an ability to enable components of the smart mailbox landing pad and charging station 101 that are not part of every configured smart mailbox landing pad and charging station 101. For example, a smart mailbox landing pad and charging station 101 may include a postage scale within this container that permits a customer to place outgoing mail and packages within the smart mailbox landing pad and charging station 101 for pickup after the appropriate amount of postage has been purchased.

The customer may purchase the postage using any of the computing devices disclosed herein including but not limited to a smartphone, tablet, public kiosk, laptop, personal computer, and the like. Alternatively, the node within the smart mailbox landing pad and charging station 101 may interact with a display and keypad that is on the face of the smart mailbox landing pad and charging station 101 to purchase the postage. In such a situation, the postage may be printed into a label to be added to the package. The postage may also be communicated to the worker who makes the pickup of the package and added once obtained.

The above example is considering the United States Postal Service (USPS) to be the carrier making the pickup and delivery. Of course, the node of the smart mailbox landing pad and charging station 101 may also communicate with other carriers, such as UPS and FedEx. The node of the smart mailbox landing pad and charging station 101 may also provide the customer with the cost required for each of these carriers and the expected transit time to permit a customer to obtain a desired deal. The additional of downloadable software to the node in the smart mailbox landing pad and charging station 101 allows a 3d party service provider to create their own applications that utilize the functions of the smart mailbox landing pad and charging station 101 for any other possible service. These 3d party service provider may implement a version of this same application onto mobile devices, a server accessible using a web browser, and kiosks that may be located spaces that may interact to ship a package or perform any function supported by the smart mailbox landing pad and charging station 101.

The smart mailbox landing pad and charging station 101 may provide additional functional capabilities through the use of peripheral devices and processing nodes as disclosed herein. These additional capacities comprise integration within an Unmanned Airport and Delivery Infrastructure, internal Environmental Control, hazard detection and mitigation of Chemical, mechanical, electrical and biological hazards, integration within a Point of Sale System, telemetry collection, storage and forwarding, integration into a Smart UAS/UAV/VTOL/eVTOL/Rooftop and Ground Airport System, and integration with a 3rd Party Delivery and Ordering System.

The unmanned airport and delivery infrastructure includes but is not limited to addition of smart mobile application development platform devices (MADP), smart mobile consumer application platform (MCAP), smart mobile application platform (MEAP), autonomous ground vehicle delivery integration, and autonomous UAS, UAV, V-TOL, EV-TOL delivery integration.

The internal environmental control includes but is not limited to addition of internal thermal insulation and soft padding in storage cavity, internal hvac digital climate control, and noise abatement measures.

The hazard detection and mitigation of chemical, mechanical, electrical and biological hazards includes but is not limited to addition of internal UV disinfectant, internal explosive trace detectors (ETD), internal biohazard scanner, internal positron emission tomography (PET), internal computerized tomography scan (CT), and bird and insect audio and sent deterrent.

The integration within a Point of Sale System includes but is not limited to addition of point of sale system integration, and point of sale delivery system integration.

The Internet of Things (IoT) integration includes but is not limited to the addition of internal camera for real time mobile app viewing of packaging and internal bar code scanning device when package is delivered.

The integration with a 3rd Party Delivery and Ordering System includes but is not limited to addition of internal rental storage space for third-party hardware storage use, smart mailbox landing pad opens vertically as a door hatch on top of the mailbox when a package is delivered., digital and manual keypad interface, manual keylock, manual use doors, slots and compartments for delivery, and receive and ship packaging.

The blockchain processing within a node of the smart mailbox landing pad and charging station includes but is not limited to blockchain delivery logistics ledger and order tracking, blockchain merchant transaction, shipping & handling and service fee processing, blockchain ledge data mining and transaction calculations, and blockchain record and tangible and intangible asset tracking and trading.

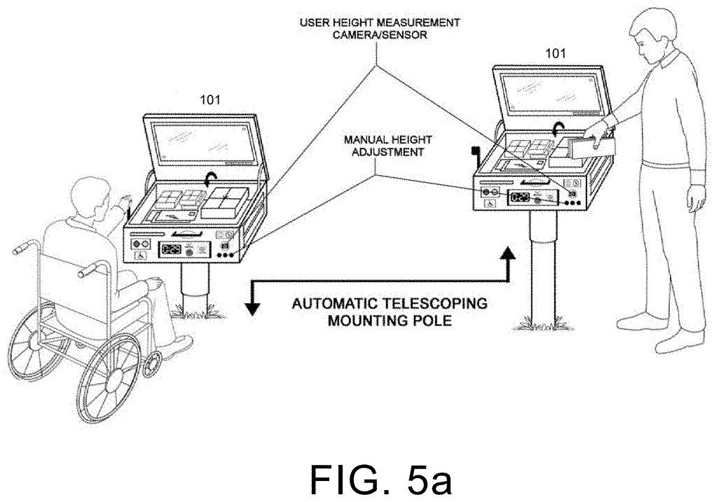

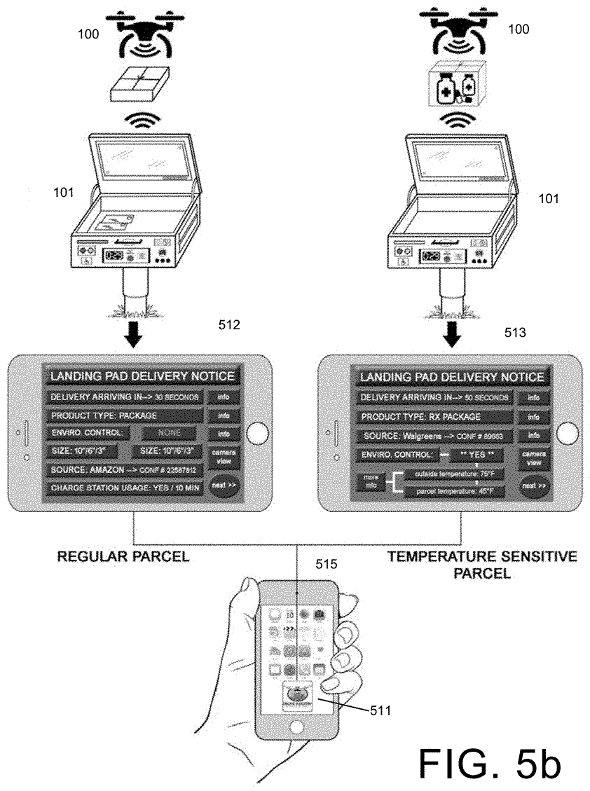

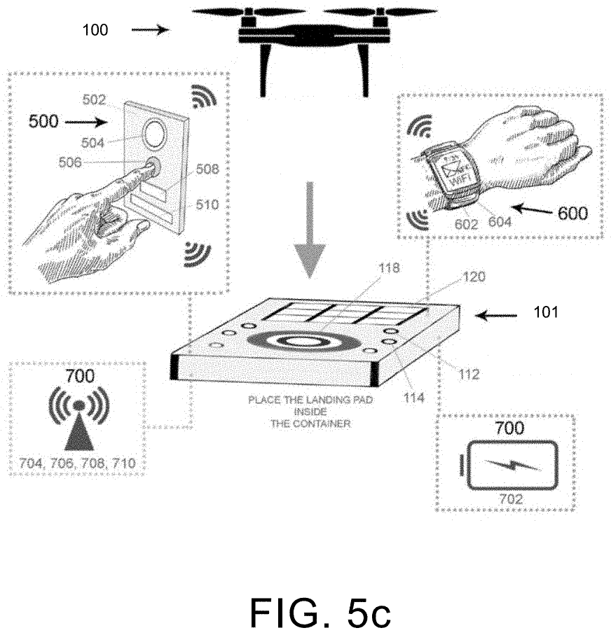

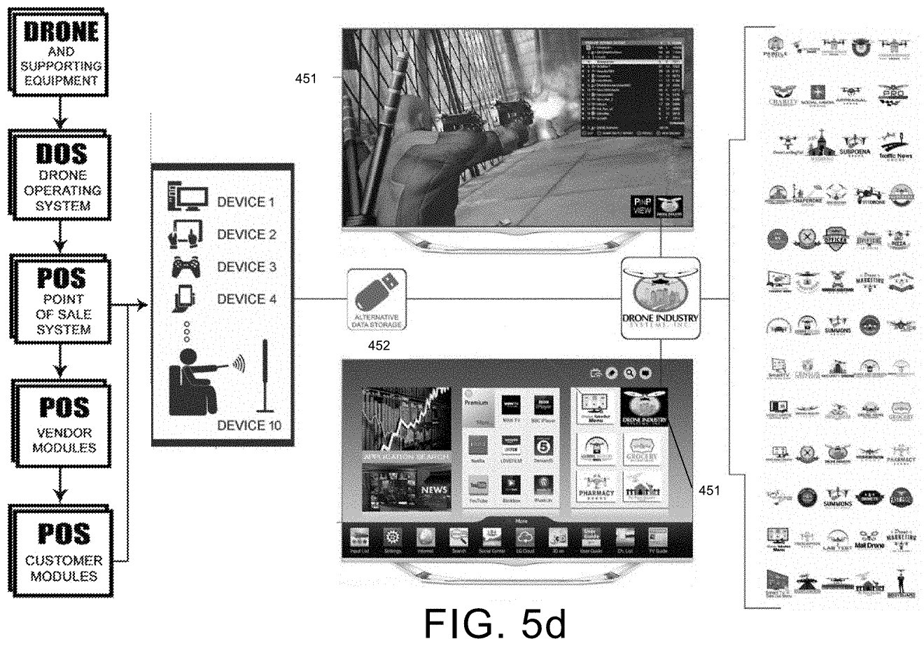

FIGS. 5a-c illustrate additional embodiments of a smart drone mailbox landing pad and charging station for use in perishable and non-perishable package delivery to a customer according to the present invention. Fig. Sa shows a smart drone mailbox landing pad and charging station 101 having an adjustable telescoping post to accommodate different users.

Fig. Sb shows a smart drone mailbox landing pad and charging station 101 communicating with a customer via a mobile application regarding a particular delivery of a perishable and or non-perishable package having sensitive environmental requirements. The customer utilizes a Downloadable In-House and Third Party Mobile interactive application 511 that is typically provided by a vendor and may be supported on mobile devices running a commercially available operating systems, including but not limited to an in house DOS, iOS, Android, etc.). The customer downloads the mobile app 511 onto mobile devices 515 including but not limited to a Mobile Phone, iPad, Laptop, Desktop, Online, etc., The mobile app 511 updates all other hardware on end user network, while updating the Smart Mailbox Landing Pad and adding functionality for each custom and specific the mobile app 511. For example, perishable and or non-perishable product being delivered may require specific hardware to support the delivery.

The mobile app 511 is tailored to accommodate the type of smart mailbox landing pad available by the customer with the specific hardware and software to achieve the needed functionality. Each mobile app 511 will have its own parameters, codes and instructions that will allow for the Smart Drone, Smart Drone Rooftop and Ground Airport, Smart Container, Spart POS System, Smart Charging Storage Garage Hanger and DOS and third Party Operating Systems to communicate with it, modify and scale it and deploy it. The mobile app 511 also displays relevant information to the customer when receives a specific type of package. For example, the delivery notice provided to the customer by the mobile app 511 may provide different information when package is an ordinary package 512 or a temperature sensitive package 513. The mobile app 511 may tailor such notifications to support any number of package types supported by the smart mailbox landing pad 101.

Fig. Sc shows a drone or smart drone 100 delivering a package to a smart drone mailbox landing pad and charging station 101 communicating with a customer regarding the delivery. The Smart Drone Mailbox Landing Pad and Charging Station 101 also incorporates a handicapped mode of operation. Here, the end-user may pre-program the mobile app. to adjust the settings of the Smart Drone Mailbox Landing Pad and Charging Station 101 to accommodate the individual disability-related needs. The adjustment may include the enlargement of the mobile app. screens, or pre-programmed height adjustment of the telescoping pole. In the event that the settings of the Smart Drone Mailbox Landing Pad and Charging Station 101 were reset to accommodate another individual, the handicapped individual will be able to reinitiate his/her custom settings, without the mobile app. by simply pushing the handicapped mode button, located on the front door.

Additionally, a Smart Doorbell and Smart Watch 600 is a hardware and software node that has both security camera features, push notification features, it turns on when it detects an object moving in front of it. The Smart Watch 600 turns on when the drone 101 has notified the smart doorbell 600 or smart watch 600 that the drone 101 is about to arrive. The Smart Watch 600 also turns on when someone physically rings the doorbell 506. A user may turn on the Smart Watch 600 if the customer simply wishes to monitor their home for security and or safety. The Smart Watch 600 allows for the end user to see the video in real time on their device (mobile or otherwise). The Smart Watch 600 automatically turns off after an end of a user receipt of goods, and end of a user request, receipt of a Smart Drone Request during completion, and/or when the package is no longer in or on the smart mailbox landing pad 101.

The Smart Drone Mailbox Landing Pad and Charging Station 101 also incorporates a smart doorbell video/audio hardware feature that allows for the end user to view and hear the package being delivered via mobile device. This will allow for the recordation, replay, archiving and distribution of the file for each delivery via cloud. The Smart Drone Mailbox Landing Pad and Charging Station 101 will communicate with the doorbell to ring the doorbell upon delivery. The OS System will provide pre-notifications to participate in the viewing of the delivery through the doorbell video/audio hardware and well as mobile push notifications to provide an additional form of alert for delivery.

FIG. 5d, illustrates a schematic from the POS Point of Sale System and POS Customer Modules, using various mobile and land devices to place an order using TV and or Smart TV 451, and Alternative USB, SIM Card, SD Card or Similar Data Storage Device. This will allow for you to access the SDAS, DOS, USSD, system(s) and its various agnostic API applications for Drone Delivery and other Drone Services, allowing for Picture in Picture Viewing while placing your order

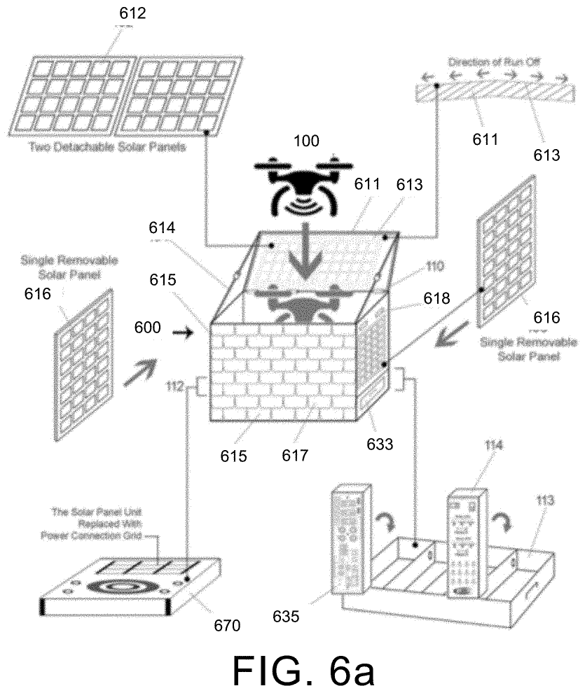

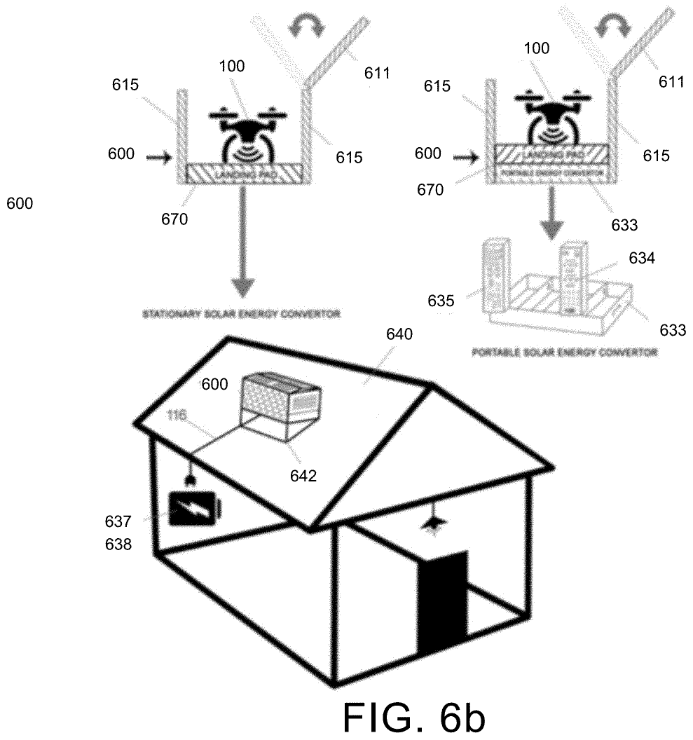

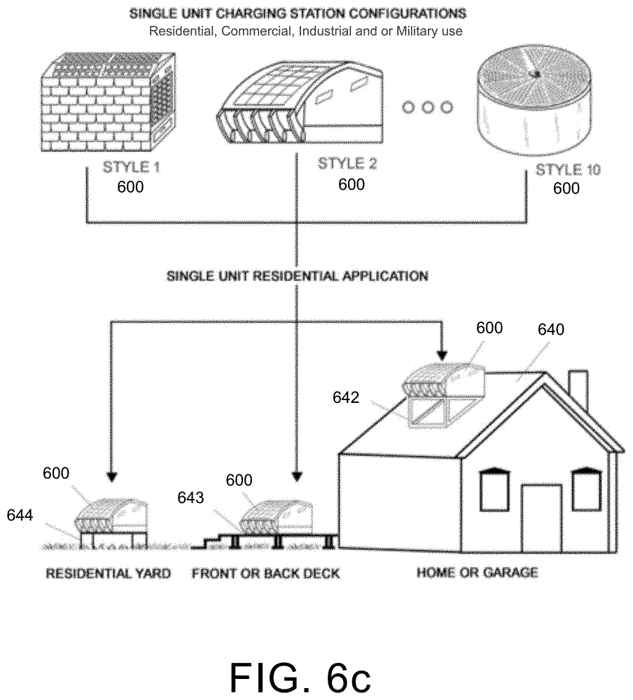

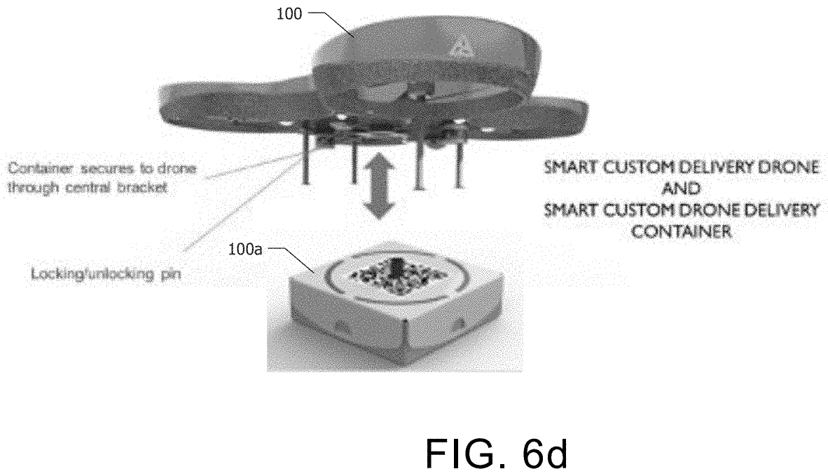

FIGS. 6a-d illustrate example embodiments of Smart Drone/Unmanned Aerial Vehicle (UAV/VTOL/eVTOL) Charging and Launching Stations according to the present invention. In addition to the smart drone mailbox landing pad and charging station 101, the SDAS 150 includes rooftop and or ground smart drone launching and charging garage/hanger stations 600. The smart drone mailbox landing pad and charging station 101 may be used to pick up items for deliveries from merchants' landing pads 101 and flown by smart drones/drones (UAV/VTOL/eVTOL) 100 to customer mailbox landing pads and charging garage/hanger station 101 for delivery. As noted herein, a smart drone 100 may seek to recharge its batteries while resting on a smart mailbox landing pad and charging garage/hanger station 101 if the landing pad 101 is so equipped. The rooftop and ground smart drone launching and charging garage/hanger stations 600 provide a longer-term storage, recharging, and servicing location for the smart drones/drones (UAV/VTOL/eVTOL) 100 when the smart drones/drones (UAV/VTOL/eVTOL) 100 are not in use.

The rooftop and ground smart drone launching and charging garage/hanger stations 600 are small stations of one or more hangers for a drone that may be located on ground surface as well as upon rooftops of buildings near locations that the smart drones/drones (UAV/VTOL/eVTOL) are intended to fly. As with all other components of the SDAS 150, the rooftop smart drone launching and charging garage/hanger stations 600 act as nodes on the system 150 that communicate with the smart drones/drones (UAV/VTOL/eVTOL) 100, the server 115, and all other nodes in the system that are authorized for use. As a node, the rooftop and ground smart drone launching and charging/drones (UAV/VTOL/eVTOL) stations 600 may download applications for execution on computing devices contained therein. Sensors, such as weather recording devices, web cameras, and the like may be attached as peripherals to the computing devices within the rooftop and ground smart drone launching and charging/drones (UAV/VTOL/eVTOL) stations 600. The data obtained from any of these peripherals may be used by other nodes in the USSN 300 as needed.

FIG. 6a shows an example embodiment of components comprising a rooftop and ground smart drone launching and charging/drones (UAV/VTOL/eVTOL) stations 600 according to the present invention. As showing in FIG. 6a, the common components of the drone docking, charging and launching station 600, include top cover 611, top solar panel and or inductive charging panel 612, top cover run off channels 613, linear actuator 614, side walls 615, side solar panel and or induction charging panel 616, side protective material 617, side multiunit clips 618, door 619, door hinges 630, retractable plate 631, landing pad compartment 6322, energy convertor drawer 633, portable energy convertor 634, portable battery 635. The drone charging station 600 includes solar panel has been replaced with a power connecting grid, designed to ensure proper connectivity between the charging station's 600 solar energy convertors 636 and 637 and the drone 100.

The solar panels 612 and 616 provide the necessary energy to operate the charging station 600 and to charge the drone 100 parked inside of said charging station 600. The unit 600 may utilize anywhere from two to eight solar panels and or inductive charging pads 612, 616. The two primary solar panels and or inductive charging pads are positioned on the top cover 611 of the charger 600. The additional solar panels 616 may be attached to the charger's 600 side walls 635. The energy captured by said solar panels and or inductive charging pads 612 and 616 is directed to the portable energy converter 114, positioned inside of the energy converter drawer 633, shown in FIGS. 1 and 2. The necessary conversion of the solar energy and or inductive pad energy may also be done by using the stationary energy convertor 637, utilizing the hard-wired connection 636.

FIG. 6b shows an example embodiment of a rooftop smart drone charging and launching/drones (UAV/VTOL/eVTOL) stations 600 according to the present invention. As shown in FIG. 6b, in situations where the stationary energy convertor 637 is utilized, the energy convertor drawer 633 may be removed, to reduce the profile of the charging station 600 visible on a building structure.

To protect from the external elements, the charging station 100 may utilize a wide variety of protective materials 617, including but not limited to wood, steel and roof shingles, as shown in FIG. 6a, which could be attached to its side walls 615. To ensure protection of a drone 100, positioned inside of the charging station 600, the top cover 611 also includes run off channels 613, designed to guide the collecting rainwater away from the charging station's 600 external structure.

FIG. 6c shows various different styles of smart drone charging and launching/drones (UAV/VTOL/eVTOL) stations 600 according to the present invention. The charging station 600 comes in two configurations: 1) single unit configuration, offering a wide variety of styles, shown in FIG. 6c, capable of forming multiple units as needed. The single configuration charging station 600, using the roof mounting brakes 642, may be attached to the roof of a residential building 640, tool shed or a garage structure. Moreover, using the deck mounting plate, the charging station 600 is perfectly suitable for mounting on a deck structure 643, as shown in FIG. 6c, or when using the ground mounting bracket 644, for positioning the charging station 600 on a lawn of either commercial or residential 640 structure.

FIG. 6d shows a smart drone/drone (UAS/UAV/VTOL/eVTOL) 100 and a non-detachable drone fixed package smart delivery container 100a but a detachable smart delivery container only for maintenance, according to the present invention. The smart drone/drone (UAS/UAV/VTOL/eVTOL) 100 is shown above a fixed non-removable smart drone/drone (UAS/UAV/VTOL/eVTOL) container that can be a removable container for maintenance only 100a for maintenance but is fixed on the drone. There is a cavity inside the smart delivery container whereby a custom sliding drawer or simply the perishable or non-perishable can be placed into and in which items for delivery may be stored in one possible embodiment of the present invention. The non-removable container 100a may provide environmental controls and be detached when arriving at a smart drone mailbox landing pad and charging station 101. In other embodiments, the container 100a may open to place its package contained therein into a storage cavity of the smart drone mailbox landing pad and charging station 101. The removable disposable/reusable packaging is a leave behind container, with the perishable and or non-perishable product, instead of actually taking the container 101a with the drone 100 after the customer has taken delivery of the perishable and or non-perishable delivery.

FIG. 7a illustrates a schematic of the smart drone rooftop and ground airport system 700 including a Smart Drone Rooftop Airport, Smart Charging/Docking Station, ATC and LAANC. 701 to receive and harbor a plurality of vehicles including drones and unmanned vehicles requiring storing and or charging before operational deployment to a destination. Drones represent in this description (“UAV's” or “Unmanned Aerial Vehicle” or “UAS” or “Unmanned Aerial Systems” or “VTOL's or “Vertical Take Off and Landing Vehicle” or “eVTOL's” or “Electric Vertical Take Off and Landing Vehicle” or “VSTOL's” or Vertical Short Take-Off and Landing Vehicles” or “STOL's” Short Take-Off and Landing Vehicles” or “eSTOL's” or “Electric Small Take-Off and Landing Vehicle” or “CTOL's” or “Conventional Take-Off and Landing Vehicle” or “eCTOL's” or “Electric Conventional Take-Off and Landing Vehicle” or “AV's” or “Autonomous Vehicles” or “CAV's” or “Connected and Autonomous Vehicles” or “Cargo Air Vehicles” or “CAV's” or Electric Cargo Air Vehicles” or “eCAV's” or “PAV's” or “Passenger Air Vehicles” or hydrogen unmanned vehicle or a hydrogen and electric unmanned vehicle hybrid or ePAV's” or “Electric Passenger Air Vehicles”).

An agnostic AI Cloud Computing Microservices System with DaaS, IaaS, PaaS, SaaS, RaaS, C-RAN, SDAS, DOS, USSN, Cyber and Network Security Network 702 in operable communication with a point-of-sale (POS) system 703 and similar auxiliary systems utilized by the Smart Drone Rooftop and Ground Airport System 704 described herein. A network 705 operates via a USSN-to-cloud communication protocol (control and command, telemetry, etc.) to communicate with the smart airport drone system 704 provided on a rooftop or similar terminal and a ground control system 706 permitting operators to control various aspects of the embodiments provided herein, which can be either ground or autonomous and virtual (VR, AR, MR). The Device Authentication Authority 308 is also utilized to receive flight plans that specify a take-off location, a proposed route, a landing location, and a remote ID associated with a specific smart drone 100. The Device Authentication Authority 308 determines whether the smart drone 100 may fly along the proposed route to land at the landing location. Once the authorization is granted and sent to the smart drone 100, the ground control station 706, and the smart mailbox landing pad 101, the flight may commence.

Each node may be characterized by at least one of the following: Node type (drone, battery, point-of-sale, rooftop, mailbox, etc.), Industry Type (Public, Private, Public Private Participation (PPP), Military), Sector type (for special-purpose applications like medical delivery or law enforcement), Unique 160-bit ID, Public-private key pair, Public-key certificate, Primary status (available or unavailable), Secondary status (additional detail), Event log, and Schedule of commitments. Each node may include the following NextGEN weather data streams, ADS-B data exchange, GPS, Drone Flight Planner (DFP), Drone Data Exchange (DDE), Drone System State (DSS), Drone Missions Database (DMDB), Device Authentication Authority (DAA), and Drone Mission Checker (DMC).

Individual nodes will publish status and event information to the DDE at regular intervals. From this, the current state of the entire system will be built and updated. Users and customers have access to another service called the Drone Request System (DRS) 303 through which they can hail services.

In some embodiments, four types of delivery order services are available for UAV delivery. Drone Industry Systems Corp Orders (DISC) taking a direct order from our customer, who are using our In-house web site or mobile app., which only allows for selecting our direct participating vendors. Vendor's direct customer order operates by a vendor taking a direct order from the customer, using the vendor's web site or mobile app., connected to our API-OEM POS operating system and UAS hailing service. Vendor in-house hailing request operates by a vendor in our DISC network, hailing a drone from our POS system for an in-house and or phone delivery order. A third party take away delivery service hailing request operate by a third party taking an order direct from their customer, using our OEM API hailing app. and UAS hailing services.

In some embodiments, nodes may include controllers, rooftop clients (r-clients), and extended clients (e-clients). Each rooftop airport will employ one controller node and as many client nodes as the rooftop can accommodate. The controller providers services to the client nodes and serves as the rooftop airports central point of contact. The controller node sends commands and configuration information to the client nodes and receives data and service requests from them. The controller and client's communication with each other over a local Wi-Fi network or similar network configuration.

In some embodiments, the controller node consists of an internet-connected computer, authentication fob, GPS transmitter, and a mobile network antenna. The computer and authentication are housed in a theft-proof container and resilient container.

In some embodiments, The Future Air Navigation System (FANS) integration modulation: to provide an option for direct data link communication between the pilot, remote pilot and the Air Traffic Controller (ATC), an Aircraft Communications Addressing and Reporting System (ACARS) communications (satellite-based), Communication, Navigation and Surveillance (CNS)/Air Traffic Management (ATM) for Air Traffic Service (ATS) Providers, and Data Link Service Providers (DSP)/Communication Service Providers (CSP). Radio or satellite technology (SatCom) may be used to enable digital transmission of short, relatively simple messages between the aircraft, UAS, UAV, VTOL, Heliport, Vertiport's and ground stations. Communications typically include the traditional: air traffic control clearances, pilot requests, and position reporting.

The goal of FANS is to improve performance related to Communication, Navigation and Surveillance (CNS)/Air Traffic Management (ATM) activities within the operating environment. Through a satellite data link integration feature, airplanes UAS, UAV, and VTOL equipped with FANS can transmit Automatic Dependent Surveillance (ADS) reports with actual position and intent information at least every five minutes. The position is based on the highly accurate Global Positioning System (GPS).

In some embodiments, a Real-time En route and Re-Route AI Weather Reporting feature from FANS and NextGen to and between airplanes UAS, UAV, and VTOL aircraft. An additional integration modulation is included for observation, prediction, UAS/UAV deployment and third-party services, that will be available with the assistance of UAS/UAVs, meteorological, networking, and operating system equipment on the UAS/UAV rooftop drone port/airport.

Information is disseminated from UAS/UAVs equipped with a UAS/UAV anemometer and or barometer, in order to create UAS/UAV Aircraft Reports (AMDAR) that were deployed from UAS/UAV rooftop drone port/airports. Common Support Services-Weather (CSS-Wx)—which publishes info provided by the NextGen weather processor and use of the system wide information management network, to the FAA and National Airspace System (NAS).

Observations are performed through the following: Next Gen CCS-Observations: Satellite imagery; Radar imagery; Aircraft reports (AMDAR); Surface reports (METARS); Upper air reports (balloon sounding), numerical modeling; Statistical forecasting including NWS forecasters, auto forecast system and forecast integration; Consolidated Storm Prediction for Aviation (CoSpa), Storm Prediction Center (SPC), UAS/UAV Weather Avoidance Field (WAF and UASWAF) Module-with UAS/UAV Deviation Model and Forecast UAS/UAV Avoidance Regions Models; Vortex 2 and 3—For Weather Chasing and reporting with UAS/UAVs, National Severe Storms Laboratories (NSSL), and UAS/UAV in-house, Mesonet and or other third-party UAS/UAV fleets.

In some embodiments, each r-client includes the following: a system-on-a-chip (SoC) computer, such as a Raspberry Pi, that is equipped with a WiFi antenna, a USB key that includes the R-client's 160-bit identification number and private key, an R-Client configuration manager that holds the 160-bit ID and public key of the Controller, an R-Client messenger tool for communicating instructions and data with the Controller, a Wi-Fi router, NFC antenna, or Bluetooth antenna to communicate with other R-Clients or, for Smart Landing Pads/Mailbox Landing Pads/Charging Stations/Hangers/Heliport, Vertiports for UAV and VTOL, that land on it.

In some embodiments, an e-client includes is any remote device or application that requests or uses the services of the rooftop airport. Examples of E-Clients include in-flight UAVs, point-of-sale systems, take away delivery apps, flight-hailing apps, public safety systems. weather-reporting systems, and logistics operators. E-Clients communicate with Controllers to request services, request data, provide data, arrange flights, and coordinate landings.

When installing the drone airport system provided herein, the Controller maintains an inventory of R-Clients. R-Clients include rooftop landing pads and other equipment associated with UAV services that share the roof To install a new R-client, the rooftop operator will (1) register the R-client's 160-bit ID in the Controller's R-Client Inventory System; (2) register the Controller's ID and public key with the R-client's configuration manager; (3) assign the R-client a fixed IP address through the Controller's Wi-Fi router; and (4) install the R-Client messenger tool on the R-client and configure it to communicate with the Controller.

In some embodiments, to reserve and implement a landing, A UAV operator uses a desktop app, POS app, web browser or mobile app to connect to the Controller's reservations homepage. He specifies “landing request” as the type of transaction, the UAV model, id, payload, date and time of arrival, and special requests related to the landing. The Controller scans its reservations system and identifies which of its R-clients can accommodate the request. After the user acknowledges the arrangements and pays any associated fees, the Controller logs the schedule in its schedule database, logs the financial transaction in its fees ledger, and sends the UAV operator the GPS coordinates of the R-client that will host the landing. The UAV operator, through its own Controller and or the end user's automated mobile app, will program the UAV with the GPS coordinates of the landing site.

FIG. 7b illustrates the communications involved in reserving and implementing a landing. As disclosed above in reference to FIG. 3b, a flight begins after a flight route is planned and submitted to the Device Authentication Authority 308. The systems Drone Flight Planner 302 creates a flight plan that specifies the takeoff and landing locations, a flight path to be followed, and the identity of the drone 100 to be flying. When the submitted flight plan is approved, the approval is sent 725 from the Device Authentication Authority 308 to the E or R-client landing pad 711 to inform it of an incoming flight. The authentication is also sent 723 to the controller 713 that oversees the flight. Lastly, the Device Authentication Authority 308 sends 724 the authentication to the UAV/Drone 717 to begin the flight. For the embodiment disclosed herein the Smart Mailbox Landing and Charging Station 100 may operate as either an E-Client or an R-client depending upon its location within the USSN 300 as otherwise disclosed herein.

When the incoming UAV 717 lands at the E or R-client 711, the R-client will communicate the landing to the Controller 713 via an operator 109, which will mark the schedule item completed and that E or R-client occupied. The landing pad 711 will use its built-in communication device (Wi-Fi router, NFC antenna, and or Bluetooth antenna) to establish communications with the newly landed UAV. All of the users of the Smart Drone Airport System (SDAS) 150 whether controlling a specific UAV 717, a rooftop airport and charging station 102, weather forecasting, Drone Flight Planner 302, Drone Request System 303, Drone State System 304, Drone Mission Checker 305, and the Device authentication Authority 308 may interact with these systems and components using a command line interpreter interface, a graphical user interface, a voice-recognition interface, and any other means of a user interacting with and specifying instructions to a computing device.

FIG. 7c illustrates the communications involved in reserving and implementing a take-off A remote requestor 109 uses a web browser or mobile app to connect to the Controller's 713 reservations homepage. He specifies “takeoff request” as the type of transaction, which of the Controller's 713 available drone models to schedule, destination GPS, and type of payload. The Controller 713 scans its inventory of available drones to identify a match. After asking for and receiving confirmation from the remote requestor, including payment of the fees associated with the takeoff, the Controller 713 submits a request to the Drone Route Planer 302 to generate the flight plan. The controller 713 sends the proposed flight plan to the Device Authentication Authority 308 for approval as disclosed above. Once the Device Authentication Authority 308 has provided its authorization to the controller 713 and the UAV 717, controller 713, at the designated takeoff time, sends GPS coordinates of the selected UAV's 717 destination to the UAV's 717 host pad through the R-client messenger tool. The host pad communicates the GPS coordinates to the UAV 717 and initiates the takeoff The host pad notifies the Controller 713 that the takeoff occurred. The Controller 713 logs the event in its schedule and resets the R-client landing pad's 711 status to available.

Besides landing pads, a rooftop may contain other E or R-clients whose services and/or data external users (E-clients) can request. For example, service providers may request low-altitude weather data from NextGen weather measurement and data collection devices. To request data from E or R-clients, a would-be consumer will access the Controller's web page to request the desired service/data set. It is up to the owner I configurator of the Controller to decide which services to make available to which E-clients and to implement the communications needed to provide the service. Based on that configuration, the Controller and R-client will coordinate fulfilling the E-clients' request. The Controller serves as the initial point of contact that authenticates and then fulfills the request.

In some embodiments, in-house and third-party APis can be customized for customer needs.

In some embodiments, the drone airport system integrates various technologies including FAA guidelines, rules and systems (dynamic integration), NASA guidelines, rules and systems (dynamic integration), Advanced Air Mobility (AAM) guidelines, rules and systems (dynamic integration), DARPA guidelines, rules and systems (dynamic integration), local, municipal, corporate, state, federal and military guidelines, rules and systems (dynamic integration), and any governmental auxiliary rule and regulation system, which requires modification (dynamic integration).

In some embodiments, current system hardware and software technologies from corporations such as CommScope and Nokia, will be available for integration into the rooftop airport in order to provide for third party technologies which will diversify the features the rooftop airport for can be scaled up or down to base on the class airport needs and requirements.

Smart city, smart building, communication and network technologies will be scalable and integrated into the rooftop airport based on the rooftop airports class, use and requirements.

Also disclosed is a universal Automated Artificial Intelligent Smart Rooftop UAS/UAV Drone Port/Airport Station, for General Purpose Services of Robotic UAS/UAVs, and its Supporting Hardware & Equipment related to Loading/Unloading, Deliveries, Deployment/Arrival, Dispatching, Air Traffic Control, Charging, Storing/Garaging, Di-Icing/Anti Icing, Meteorological & Data Dissemination/Retrieval, Big Data Mining, and MIMO Network Services; (“UAS” or “Drone Airport System” or “DAS”). Said Drone Airport System operation are supported by the Drone Operating System (“DOS), and provides the following capabilities: 1) Drone on demand delivery services; 2) Drones are parked, stored and or charging in the drone garage and or on a drone 3) landing pad; 4) Orders are made via mobile, land, and TV applications using wire and or wireless connections; 5) Drone AI Cloud (Artificial Intelligence Cloud) figures out if the weather permits deliver to and from the location requested at the time requested; 6) Drone AI Cloud will figure out which drone is available, using the fastest, most convenient, safest and properly equipped drone for the weather conditions, payload requirements, and any other specific demand option(s); 7) The UTM deploys the Drone to the Landing pad for loading/unloading, drop off and pickup; 8) The Drone is loaded and departs to its destination; 9) The Drone delivers arrives at its destination, confirms the receiver of the package, releases the product to the consumer and informs the POS that the order has been delivered; 10) The Drone AI then selects either the drone's next destination for charging, based upon its remaining battery use, sends it to its next order, or parks it at the nearest Drone AirPort Parking Station where it can recharge and wait for further instructions; 11) All Rooftop UAS/Drone Hardware, Exterior and or Interior Equipment and Landing Pad equipment will have a water proof option such as superhydrophobic (water) and oleophobic (hydrocarbons) coating, that will completely repel almost any liquid and or nanotechnology coating, to coat an object and create a barrier of air on its surface; 12) All UAS/Drone(s) that deploy will have the option to use UAS. UAV de-icing inflatable boot Equipment© on the leading and trailing edges(s) of the propeller arm(s); 13) All UAS/Drone Hardware will have impact protections options, using products like Mashable D30 Crystalex Clear Formable Elastomer Material for Protective Gear on the UAS/Drone for Drop Test Crash Resistances; 4) All UAS/Drone Hardware will have Nanocrystalline Metal Alloy options for lighter, stronger, and more efficient, UAS.

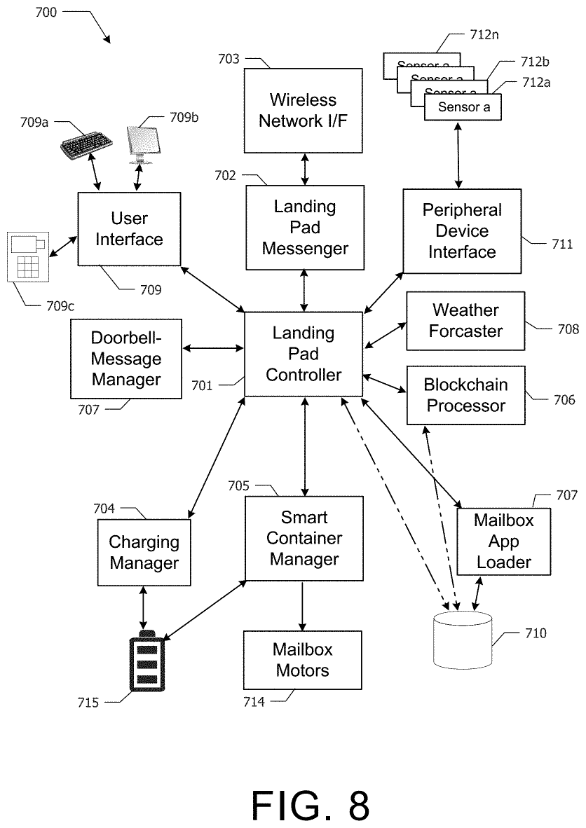

FIG. 8 illustrates a computing system of software components 800 of a system providing a smart drone mailbox landing pad and charging station according to the present invention. FIG. 8 shows a charging station set of computing components 800 used within a smart drone mailbox landing pad and charging station 101 that is one node in a larger Smart Drone Airport System (SDAS) 150 as disclosed above. The smart drone mailbox landing pad and charging station set of software components 800 running within a smart drone mailbox landing pad and charging station 101 include a landing pad controller 801, a landing pad messenger 802, a wireless network interface 803, a smart drone mailbox landing pad and charging station charging manager 804, a smart drone mailbox landing pad and charging station smart container device manager 805, a blockchain processor 806, a smart drone mailbox landing pad and charging station app loader 807, a weather forecaster 808, a user interface 809 coupled to input and display devices 809a-c, local data storage 810, a peripheral device interface 811, one or more attached devices 812a-n, smart drone mailbox landing pad and charging station motors 814, and internal battery 815.

The smart drone mailbox landing pad and charging station controller 801 receives drone retrieval and dispatch commands for use in moving the smart drone/drone (UAS/UAV/VTOL/eVTOL) 100 from the vendor establishments to customers landing pads 101, and images, text, logos, and related advertising material data via the wireless network interface 803 from the Drone Airport System (DAS) 150 and its various processing systems. The smart drone mailbox landing pad and charging station controller 801 also interacts with the remaining set of processing components to cause the smart drone mailbox landing pad and charging station 101 to receive, charge, store, and dispatch smart drones/drones (UAS/UAV/VTOL/eVTOL) 100 from one location to another to both pick up items from vendor establishments as well as deliver these items to customers as needed.

The smart drone mailbox landing pad and charging station controller 801 executes on computing hardware that is contained within the smart drone mailbox landing pad and charging station 101. The particular computing hardware of the smart drone mailbox landing pad and charging station controller 801 may be configured to support various levels of data processing throughput that may be utilized within the smart drone mailbox landing pad and charging station controller 801. The specific computing hardware may be modularly configured, uploaded and or downloaded software to allow easy upgrades to the processing capacity of the smart drone mailbox landing pad and charging station controller 801 as needed.

As otherwise disclosed herein, the smart drone mailbox landing pad and charging station 101 is a node on the USSN 300 that may be addressed and interfaced by other nodes on the USSN 300. Because the smart drone mailbox landing pad and charging station controller 801 may execute instructions contained within software packages loaded into the smart drone mailbox landing pad and charging station controller 801, the smart drone mailbox landing pad and charging station 101 may perform any number of different operations in addition to receiving deliveries from smart drones 100 for customers.

The smart drone mailbox landing pad and charging station controller 801 may interact with the smart drone mailbox landing pad and charging station app loader 807 to download mobile applications that may execute within the smart drone mailbox landing pad and charging station controller 801. These mobile applications may utilize and collect data from the attached peripheral devices 812a-n and provide this data to any other node in the USSN 300. For example, a mobile application may collect local weather data near the smart drone mailbox landing pad and charging station 101 that may be shared with the UTM web server 115, any number of smart drones/drones (UAS, UAV, VTOL, eVTOL) 100, and related shippers, customers, and merchants. This local weather data may also be provided to other third parties who may desire to obtain and use the weather data for other purposes. The USSN 300 may offer access to this data in exchange for a fee.

In addition to weather data, the smart drone mailbox landing pad and charging station 101 also includes cameras 809c that obtain real-time views of the area in the vicinity of the smart drone mailbox landing pad and charging station 101. These images and video data streams may be collected by the smart drone mailbox landing pad and charging station controller 701 and provided to any node on the USSN 300 as desired. Many other sensors, input data, and the like may be collected using the attached peripherals 812a-n that may be provided to other nodes in the USSN 300.

The smart drone mailbox landing pad and charging station messenger 802 assists the smart drone/drone (UAS/UAV/VTOL/eVTOL) 100 to send and receive data over the wireless network 110. The smart drone mailbox landing pad and charging station controller 701 communicates with processing components within the DAS 150 to obtain orders and associated destinations, to obtain images, text, logos, and related advertising material data via the wireless network interface 803, and status, health and location information periodically to permit the DAS 150 to monitor the activity of the smart drones/drone (UAS/UAV/VTOL/eVTOL) 100. This communication is performed with the exchange of commands and related messages that are generated, monitored, and acknowledged by the mailbox messenger 802 to maintain communications with the DAS 150 as needed.

In addition, the smart drone mailbox landing pad and charging station mailbox messenger 802 may provide delivery confirmation to various interested parties including the SDAS 150 server 115, a shipping provider, a merchant using the smart drone/drone (UAS/UAV/VTOL/eVTOL) for a delivery, and a customer receiving a delivery. These notification messages may be sent to smartphones and other mobile devices, to mobile apps used by any of the above parties, and computing systems of any of the above parties that communicate with nodes on the SDAS 150.

The wireless network interface 803 permits the station controller 801 and other components to communicate with remote computing devices that are part of the DAS 150 and its various processing systems. The wireless network interface 803 performs all of the data formatting, computer-to-computer communications, encryption processing, and all similar operations needed by the smart drone mailbox landing pad and charging station controller 801 and the DAS 150 and its various processing systems to communicate with each other as needed.

The smart mailbox landing pad and charging station charging manager 804 monitors the charging activity of batteries within the smart mailbox landing pad and charging station 101. The smart mailbox landing pad and charging station charging manager 804 monitors the current state of charge of these batteries and determines an expected completion time for the recharging of each battery. The smart mailbox landing pad and charging station charging manager 804 uses this data to monitor the health of the batteries in use by the smart mailbox landing pad and charging station 101 to identify batteries that need servicing. The smart mailbox landing pad and charging station charging manager 804 provides the current state of the batteries to the UTM web server 115 for use in dispatching any maintenance or service personnel as needed. The batteries 815 are used to power the smart mailbox landing pad and charging station 101 when direct electrical power is not available to the smart mailbox landing pad and charging station 101, to recharge smart drones/drones (UAS/UAV/VTOL/eVTOL) 100 that may land at the smart mailbox landing pad and charging station 101, and to provide power to any attached peripherals 812a-n that are collecting data for use by other nodes in the SDAS 150.

The smart mailbox smart container device manager 805 controls access to a package cavity within smart mailbox landing pad and charging station 101 to receive and hold packages for their intended recipient. The smart mailbox landing pad smart container device manager 805 activates the doors 611 and related devices that are part of the smart mailbox landing pad and charging station 101. The smart mailbox landing pad smart container device manager 805 identifies the particular smart drone/drone (UAS/UAV/VTOL/eVTOL) 100 landing at the smart drone mailbox landing pad and charging station 101 to the UTM web server 115.

The blockchain processor 806 may be used by the smart drone mailbox landing pad and charging station controller 801 to create a permanent and trusted record of all transactions involving deliveries to the smart drone mailbox landing pad and charging station 101. Each delivery may be recorded including the date, time, weather conditions, a description of the delivered packages, images collected at the time the packages are received and retrieved, shipping, shipper, receiver logging, flight logging, and any other relevant data associated with the smart mailbox landing pad and charging station 101. The blockchain processor 806 adds the data entry to its block chain ledger and performs all of the processing to ensure its inclusion into the permanent record. Because a blockchain ledger obtains tamperproof security over the ledger by maintaining an identical copy of the ledger on multiple platforms, these entries may be sent to any number of other nodes in the USSN 300 for inclusion in all of the copies of the ledger.

A ledger may provide recording of all of the nodes in the USSN 300, or more likely, various subsets of nodes depending upon the volume of entries to be generated and the processing capacity of the smart drone mailbox landing pad and charging station controller 801. Any interested and or authorized party may retrieve ledger entries associated with a delivery to a particular smart drone mailbox landing pad and charging station 101 by retrieving the data from any of the nodes that are sharing the ledger for the particular smart drone mailbox landing pad and charging station 101. The blockchain processor 806 stores any of its ledger data onto the local data storage 710 as needed.

Additionally, the USSN 300 may provide available processing capacity and available physical storage of the smart drone mailbox landing pad and charging station controller 801 and any other nodes in the USSN 300 to third parties to maintain their own blockchain ledger, logging, mining, and recording to leverage the distributed computing capacity of all of the smart drone mailbox landing pads and charging stations 101 in the USSN 300. Any excess processing capacity of the smart drone mailbox landing pad and charging station controllers 801 in the smart drone mailbox landing pads and charging stations 101, may also be provided to third parties for use as distributed computing resources.

The smart drone mailbox landing pad and charging station app loader 807 provides the capability to download mobile applications from the UTM web server 115 or similar data sources for execution by the smart drone mailbox landing pad controller 801. The smart drone mailbox landing pad and charging station app loader 807 will download the mobile applications and store them in the local data storage 810 for use when instructed. When the smart drone mailbox landing pad and charging station app loader 807 receives commands to perform a desired function, the mobile application is retrieved from local data storage 810 and provided to the smart mailbox landing pad and charging station controller 801 to run. Updates to existing mobile applications may be obtained and applied to the smart drone mailbox landing pad and charging station controller 810 when available. The smart drone mailbox landing pad and charging station app loader 807 enables the smart drone mailbox landing pad and charging station controller 801 to become an available cloud-based computing resource that may provide computing services based upon any unused processing capacity of each node in the USSN 300.

The station weather forecaster 808 obtains current weather condition data from sensor devices located at the charging station 600 and smart drone mailbox landing pads and charging stations 101. The station weather forecaster and real time weather 808 attaches a time stamp and observation location of the particular station to create weather observation data that is transmitted to the UTM web server 115 for use in monitoring the forecasted and current weather and routing the smart drones/drones (UAS/UAV/VTOL/eVTOL) 100 making deliveries. The station weather forecaster can provide third party surface and Very Low Level Weather Reporting and Meta Data needed for both forecasted and current real time weather that can be converted for example into virtual Terminal Aerodrome Forecast (TAFs) and Meteorological Aerodrome Reports (METARs) for data and charts or provide AIRman's Meteorological Information (AIRMETs) and Significant Meteorological Information (SIGMETs) by way of conversion into data and charts. Another example is Surface and Low Level Wake Turbulence forecast data and charts. Weather peripherals, hardware and software are interoperable modular and scalable on the Smart Drone Mailbox Landing Pad and Charging Station 101.

The user interface 809 coupled to input and display devices 809a-c provides input and output processing to provide a user with access to the smart drone mailbox landing pad and charging station. This interface module 809 also accepts commands from the driver to instruct the application to perform these tasks. The users interact with the smart drone mailbox landing pad and charging station 101 using various display devices 809b and input devices 809a, c including LED and touch screen display devices, keyboards and keypads, and cameras and microphones to provide biometric identification and voice commands. The user interface 809 allows any of the input and output devices to operate within the smart drone mailbox landing pad and charging station 101.

The peripheral device interface 811 coupled to any attached devices 812a-n provides an interoperability with generic and interconnection of external devices to the smart drone mailbox landing pad and charging station controller 801. The peripheral device interface 811 transmits commands and blockchain mining, logging, ledgering, and recording to the attached devices 812a-n and receives any data generated therein with the smart drone mailbox landing pad and charging station controller 801. The peripheral device interface 811 may include one or more data connection protocols and physical data transmission channels used to connect computing devices to each other. These data connections may comprise wired connections such as USB-A, USB-C, Firewire™, Thunderbolt™, ethernet, and other serial and parallel data connections. These data connections also may comprise wireless connections including WiFi, Bluetooth, IR, 3G, 4G LTE, 5G, and other wireless communication protocols.

The smart drone mailbox landing pad and charging station motors 814 controls all mechanical devices that are part of the smart drone mailbox landing pad and charging station 101. The package cavity may be accessed using locking devices, motorized opening doors and lids, and similar motorized devices. The smart drone mailbox landing pad and charging station motors 814 receives commands from the smart drone mailbox landing pad and charging station controller 801 and activates and deactivates these mechanical devices to allow users to gain access to the smart drone mailbox landing pad and charging station 101. The smart drone mailbox landing pad and charging station motors 814 also may control any environmental control devices within the smart drone mailbox landing pad and charging station 801 to maintain a condition of a particular delivered package.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

In the present application, all or any part of the invention's software or application(s) or smart device application(s) may be installed on any of the user's or operator's smart device(s), any server(s) or computer system(s) or web application(s) required to allow communication, control (including but not limited to control of parameters, settings such as for example, sign copy brightness, contrast, ambient light sensor settings . . . etc.), transfer of content(s) or data between any combination of the components.

What is claimed is:

1. A system for providing a smart drone mailbox landing pad and charging station as part of a drone unmanned system service network, the drone unmanned system service network communicatively connects the smart drone mailbox landing pad and charging station, one or more autonomous drones, one or more drone service function devices, blockchain harvesting, mining, logging, ledgers, and recording, to provide autonomous drone package delivery over a communications network, the smart drone mailbox landing pad and charging station comprises:
a processing node having a processor, memory, a storage device, and a network connection to one or more communications networks;
a drone landing pad;
an induced charging pad configured to recharge a battery within one of the one or more drones;
one or more external webcams;
weather condition measuring equipment to obtain current weather conditions about the smart drone mailbox landing pad and charging station; and
a package receiving container for accepting a delivered package.

2. The smart drone mailbox landing pad and charging station according to claim 1, wherein the one or more autonomous drones comprises an unmanned aircraft system, an unmanned aircraft vehicles, a vertical take-off and landing vehicle, an electric vertical take-off and landing vehicle, a vertical short take-off and landing vehicle, an electric vertical short take-off and landing vehicle, a short take-off and landing vehicle, an electric short take-off and landing vehicle, a conventional take-off and landing vehicle, an electric conventional take-off and landing vehicle, a cargo air vehicle, an electric cargo air vehicle, a passenger air vehicle, a hydrogen unmanned vehicle, a hydrogen and electric unmanned vehicle hybrid, and an electric passenger air vehicle.

3. The smart drone mailbox landing pad and charging station according to claim 1, wherein the smart drone mailbox landing pad and charging station further comprises:
a telescoping support tube;
landing sensors;
beacon lights;
solar panels;
a display device; and
an input keypad.

4. The smart drone mailbox landing pad and charging station according to claim 3, wherein the package receiving container comprises:
an automatic opening and locking access point;
temperature and environmental control system;
modular storage components;
internal sensors; and
an internal webcam.

5. The smart drone mailbox landing pad and charging station according to claim 3, wherein the smart drone mailbox landing pad further comprises:
a remote smart doorbell; and
a wireless smart watch;
wherein the remote smart doorbell and the wireless smart watch receive package delivery notification from the processing node within the smart drone mailbox landing pad and charging station upon receipt of a package.

6. The smart drone mailbox landing pad and charging station according to claim 3, wherein the processing node within the smart drone mailbox landing pad and charging station downloads mobile applications containing executable instructions for the processor to perform from a 3d party vendor.

7. The smart drone mailbox landing pad and charging station according to claim 4, wherein the node within the smart drone mailbox landing pad and charging station communicates with a network controller of the one or more autonomous drones to receive authorization for a particular drone to land.

8. The smart drone mailbox landing pad and charging station according to claim 7, wherein the node within the smart drone mailbox landing pad communicates with the particular drone to provide authorization to land.

9. The smart drone mailbox landing pad and charging station according to claim 1, wherein the smart drone mailbox landing pad and charging station further comprises one or more supported capacities, the supported compacities comprise:
integration within an Unmanned Airport and Delivery Infrastructure;
internal environmental control;
hazard detection and mitigation of Chemical, mechanical, electrical and biological hazards;
integration within a Point of Sale System;
telemetry collection, storage and forwarding;
integration into a Smart UAS/UAV/VTOL/eVTOL/Rooftop and Ground Airport System; and
integration with a 3rd Party Delivery and Ordering System.

10. The smart drone mailbox landing pad and charging station according to claim 1, wherein the smart drone mailbox landing pad and charging station further comprises weather condition measuring equipment to obtain current weather conditions about the smart drone mailbox landing pad and charging station.

11. The smart drone mailbox landing pad and charging station according to claim 10, wherein the node within the smart drone mailbox landing pad and charging station provides the current weather conditions to the one or more autonomous drones and the one or more drone service function devices of the drone unmanned system service network.

12. The smart drone mailbox landing pad and charging station according to claim 11, wherein the one or more drone service function devices of the drone unmanned system service network comprise a drone pre-flight inspections, drone flight planner, a drone request system, a drone system state device, a drone mission checker, a device authentication authority, a point-of-sale system, and one or more unmanned rooftop and or ground airports, drone garages and or hangers and charging stations.

13. The smart drone mailbox landing pad and charging station according to claim 11, wherein the node of the smart drone mailbox landing pad and charging station further comprises:
a peripheral interface for connecting 3rd party devices for use by the node; and
a blockchain processor of providing a blockchain harvesting, mining, logging, ledger and recording for use with other blockchain harvesting, mining, logging, ledgers, and recording, in other nodes within the drone unmanned system service network to provide a secure and redundant record of all deliveries and autonomous drone flights.

14. The smart drone mailbox landing pad and charging station according to claim 11, wherein the blockchain processor is accessible by 3rd party nodes.

15. The smart drone mailbox landing pad and charging station according to claim 13, wherein the 3rd party nodes may be added to the smart drone mailbox landing pad and charging station to provide functionality of the downloaded mobile applications.

16. The smart drone mailbox landing pad and charging station according to claim 15, wherein the 3rd party nodes added to the smart drone mailbox landing pad and charging station utilize a separate processor and memory components.

17. The smart drone mailbox landing pad and charging station according to claim 16, wherein the 3rd party nodes utilize a separate network connection to communicate with other nodes.

18. The smart drone mailbox landing pad and charging station according to claim 3, wherein the smart drone mailbox landing pad and charging station further comprises a battery for use when solar panels and or inductive charging pads are not sufficient to support the node of the smart drone mailbox landing pad and charging station.

19. The smart drone mailbox landing pad and charging station according to claim 3, wherein the smart drone mailbox landing pad and charging station further comprises a remote control device to operate the nodes of the smart drone mailbox landing pad and charging station.

20. The smart drone mailbox landing pad and charging station according to claim 3, wherein the telescoping operates automatically in a handicap user mode to raise and lower the smart drone mailbox landing pad.
